(19) United States
(12) Patent Application Publication
(10) Pub. No.: US 2011/0087606 A1
(43) Pub. Date: Apr. 14, 2011

(54) SYSTEMS AND METHODS FOR PROCESSING MERCHANDISE RETURNS

(76) Inventors: Mark S. Hammond, Laguna Beach, CA (US); Mark R. Hilinski, Claremont, CA (US); David B. Speights, Tustin, CA (US); Thomas W. Rittman, Brecksville, OH (US); Peter L. Bradshaw, San Clemente, CA (US)

(21) Appl. No.: 12/899,453

(22) Filed: Oct. 6, 2010

Related U.S. Application Data
(60) Provisional application No. 61/249,509, filed on Oct. 7, 2009.

(51) Int. Cl. G06Q 30/00

(52) U.S. Cl. 705/304

(57) ABSTRACT

Systems and method for processing merchandise returns are described. In some embodiments, a sales receipt can be received in connection with a requested merchandise return. A receipt identifier can be used to locate sales data associated with the original purchase of the merchandise being returned, and a customer identifier (e.g., a customer loyalty number or a hashed credit card number) can be extracted from the sales data. Customer information, such as prior merchandise return data or prior purchase data, can be retrieved using the extracted customer identifier. The customer information can be used to assess the risk associated with the requested merchandise return for making a determination of whether to accept or deny the return request. Determinations can also be made for whether to provide the customer with a warning or with a coupon in connection with the merchandise return. In some embodiments, multiple customer identifiers can be extracted from a transaction within the sales data and an association can be stored between the multiple extracted customer identifiers. The association can indicate that both customer identifiers relate to a single customer. Then, if a request is later made for customer data associated with a first customer identifier, a response an include customer data for the first customer identifier as well as customer data for other customer identifiers associated with the first customer identifier.

### CROSS-REFERENCE TO RELATED APPLICATIONS

This application claims the benefit under 35 U.S.C. §119(e) of U.S. Provisional Patent Application No. 61/249,509, entitled SYSTEMS AND METHODS OF RECEIPT TRIANGULATION, filed Oct. 7, 2009 (Atty. Docket No. RETEX.058PR), the entirety of which is hereby incorporated by reference and made a part of this specification.

### BACKGROUND OF THE INVENTION

1. Field of the Invention

Some embodiments of the present invention relate to the automated processing of merchandise returns, and more particularly to automated identifying of a consumer associated with a merchandise sale or return to determine an appropriate response to a merchandise request.

2. Description of the Related Art

Determining when to allow retail customers to return purchased merchandise is a delicate and complex business decision that many merchants face. On the one hand, customers typically appreciate, and have come to expect, a liberal return policy. Such a policy can engender good will towards the merchant and often encourages the customer to purchase more freely, indulging more often in “impulse buying.” On the other hand, accepting returned merchandise can expose the merchant to a number of disadvantages, including, for example, loss of a sale, possible inability to re-sell the item at the original price, extra labor and bookkeeping expenditures associated with handling the return, and a wide variety of abusive or fraudulent behaviors on the part of the customer and/or employee accepting the return.

Although automated systems for implementing a merchant's return policy exist, there remains a need for improvement.

### SUMMARY OF THE INVENTION

Certain example embodiments disclosed herein are summarized below. A method for determining the level of risk associated with a requested merchandise return is disclosed. The method can include receiving a sales receipt identifier for a sales receipt associated with a requested merchandise return made by a consumer, accessing one or more databases stored in a computer readable medium to identify sales data associated with the sales receipt identifier for the requested merchandise return, extracting a customer identifier from the sales data associated with the sales receipt identifier, accessing the one or more databases to identify customer data associated with the customer identifier obtained from the sales data, and automatically determining, using a return authorization system that includes one or more computer processors in communication with the computer readable medium, the level of risk associated with the requested merchandise return can be based at least in part on the customer data associated with the customer identifier obtained from the sales data.

The method can further include determining, using the return authorization system, whether to authorize or deny the requested merchandise return based at least in part on the level of risk associated with the requested merchandise return. The method can further include automatically determining, using the return authorization system, to restrict future returns made by the consumer based at least in part on the level of risk associated with the requested merchandise return. The method can further include preparing a warning relating to the restricted future returns to be presented the consumer.

The customer data can include prior merchandise return data associated with the customer identifier, and the determination of the level of risk associated with the requested merchandise return can be based at least in part on the prior merchandise return data. The customer data can include sales data associated with prior purchases associated with the customer identifier, and the determination of the level of risk associated with the requested merchandise return can be based at least in part on the sales data associated with the prior purchases.

The customer data can include the consumer's address. The method can further include accessing the one or more databases to identify merchandise return data associated with one or more additional consumers that have the same address as the consumer associated with the customer identifier, and the determination of the level of risk can be determined at least in part by the merchandise return data associated with the one or more additional consumers.

The customer identifier can be a customer loyalty number, a hashed credit card number, a hashed debit card number, a hashed checking account number, or a merchant-specific customer ID number.

The method can further include extracting a second customer identifier from the sales data associated with the sales receipt identifier. The method can further include identifying customer data associated with the second customer identifier, and the determination of whether to authorize or deny the requested merchandise return can be based at least in part on customer data associated with the second customer identifier. The method can further include storing in the one or more databases an association between the initial customer identifier and the second customer identifier.

The method can further include identifying one or more additional customer identifiers that are associated with the initial customer identifier, and the determination of whether to authorize or deny the requested merchandise return can be based at least in part on customer data associated with the one or more additional customer identifiers.

A method for determining whether to authorize a requested merchandise return is disclosed. The method can include receiving sales data associated with merchandise purchases made by one or more consumers, receiving merchandise return data associated with merchandise returns made by the one or more consumers, storing the sales data and the merchandise return data in one or more databases stored in a computer readable medium, receiving a sales receipt identifier for a sales receipt associated with a requested merchandise return made by a consumer, accessing the one or more databases to identify the sales data associated with the sales receipt identifier for the requested merchandise return, extracting a customer identifier from the sales data for the requested merchandise return, identifying prior merchandise return data associated with the same customer identifier obtained from the sales data, and automatically determining, using a return authorization system that includes one or more computer processors in communication with the computer readable medium, whether to authorize or deny the requested merchandise return based at least in part on the prior merchandise return data.

The method can further include receiving requested merchandise return data for the requested merchandise return, and the determination of whether to authorize or deny the requested merchandise return can be based at least in part on the requested merchandise return data. The method can further include accessing sales data associated with prior purchases associated with the customer identifier, and the determination of the level of risk associated with the requested merchandise return can be based at least in part on the sales data associated with the prior purchases. The method can further include notifying the consumer of whether the requested merchandise return is authorized or denied. The method can further include determining, using the return authorization system, whether to restrict future merchandise returns made by the consumer.

The method can further include extracting a second customer identifier from the sales data for the requested merchandise return. The method can further include identifying prior merchandise return data associated with the second customer identifier for the requested merchandise return, and the determination of whether to authorize or deny the requested merchandise return can be based at least in part on prior merchandise return data associated with the second customer identifier. The method can further include storing in the one or more databases an association between the merchandise return data associated with the initial customer identifier and the merchandise return data associated with the second customer identifier.

The method can further include identifying one or more additional customer identifiers that are associated with the extracted customer identifier, and the determination of whether to authorize or deny the requested merchandise return can be based at least in part on prior merchandise return data associated with the one or more additional customer identifiers.

A system for determining whether to authorize a requested merchandise return is disclosed. The system can include one or more databases stored in a computer readable medium that includes sales data associated with merchandise purchases made by one or more consumers, and merchandise return data associated with merchandise returns made by the one or more consumers. The system can further include a customer identifier extraction system configured to receive a sales receipt identifier for a sales receipt associated with a requested merchandise return made by a consumer, access the one or more databases to identify the sales data associated with the sales receipt identifier for the requested merchandise return, and extract a customer identifier from the sales data for the requested merchandise return. The system can further include a return authorization system configured to access the one or more databases to identify prior merchandise return data associated with the same customer identifier extracted from the sales data, and determine whether to authorize or deny the requested merchandise return based at least on the prior merchandise return data.

The return authorization system can be configured to receive requested merchandise return data for the requested merchandise return, and determine whether to authorize or deny the requested merchandise return based at least in part on the requested merchandise return data.

The customer identifier extraction system can be configured to extract a second customer identifier from the sales data for the requested merchandise return. The return authorization system can be configured to identify prior merchandise return data associated with the second customer identifier extracted from the sales data, and determine whether to authorize or deny the requested merchandise return based at least in part on the prior merchandise return data associated with the second customer identifier. The customer identifier extraction system can be configured to store in the one or more databases an association between the merchandise return data for the initial customer identifier and the merchandise return data for the second customer identifier.

The customer identifier extraction system can be configured to search the one or more databases to identify one or more additional customer identifiers that are associated with the extracted customer identifier, and the authorization system can be configured to determine whether to authorize or deny the requested merchandise return based at least in part on prior merchandise return data associated with the one or more additional customer identifiers.

A system for identifying previous purchases made by a consumer is disclosed. The system can include one or more databases stored in a computer readable medium comprising sales data associated with merchandise purchases made by one or more consumers, and a customer identifier extraction system configured to receive a sales receipt identifier for a sales receipt associated with one of the merchandise purchases previously made by a consumers, access the one or more databases to identify the sales data associated with the sales receipt identifier for the purchase previously made, and extract a customer identifier from the sales data associated with the sales receipt identifier. The system can also include a data collection system configured to access the one or more databases to identify customer data associated with the customer identifier extracted from the sales data associated with the receipt identifier.

The receipt can be associated with a requested merchandise return made by the consumer, and the system can further include a return authorization system configured to determine the level of risk associated with the requested merchandise return based at least in part on the customer data associated with the customer identifier obtained from the sales data associated with the receipt identifier. The return authorization system can be configured to determine whether to authorize or deny the requested merchandise return based at least in part on the level of risk associated with the requested merchandise return. The return authorization system can be configured to determine whether to restrict future returns made by the consumer based at least in part on the level of risk associated with the requested merchandise return.

The system can further include a coupon generation system configured to determine an appropriate coupon to offer the customer based at least in part on the customer data associated with the customer identifier obtained from the sales data associated with the receipt identifier. The customer data comprises prior sales data, and the data collection system is configured to access the one or more databases to identify the prior sales data for one or more additional prior purchases associated with the same customer identifier extracted from the sales data associated with the receipt identifier, and the coupon generation system can be configured to determine the appropriate coupon to offer the customer based at least in part on the prior sales data. The customer data comprises prior merchandise return data, and the data collection system can be configured to access the one or more databases to identify the prior merchandise return data associated with merchandise returns previously performed by the customer, and the coupon generation system can be configured to determine the appropriate coupon to offer the customer based at least in part on the prior merchandise return data. The coupon generation system can be configured to determine whether to offer the customer a coupon based at least in part on the customer data associated with the customer identifier. The receipt can be associated with a requested merchandise return made by the consumer.

A method for tracking merchandise purchases of consumers is disclosed. The method can include receiving sales data associated with merchandise purchases made by one or more consumers, storing the sales data in one or more databases stored in a computer readable medium, obtaining sales data associated with a particular purchase made by a consumer, extracting, using a customer identifier extraction system, a first customer identifier from the sales data associated with a particular purchase made by a consumer, extracting, using the customer identifier extraction system, a second customer identifier from the sales data associated with a particular purchase made by a consumer, and storing, in the one or more databases, an association between the first customer identifier and the second customer identifier.

The method can further include receiving a request for customer data associated with the first customer identifier, accessing the one or more databases, using a data collection system, in response to the request and identifying customer data associated with the first customer identifier, identifying the association between the first customer identifier and the second customer identifier, accessing the one or more databases, using a data collection system, in response to the request and identifying customer data associated with the second customer identifier, and providing a response to the request, the response comprising the customer data associated with the first customer identifier and the customer data associated with the second customer identifier.

Obtaining the sales data associated with the particular purchase can include receiving a receipt identifier associated with the receipt associated with the requested merchandise return made by the consumer, and accessing the one or more databases to identify the sales data for the particular purchase relating to the requested return. Obtaining the sales data associated with the particular purchase can include receiving the sales data associated with the particular purchase in response to the customer making the particular purchase.

### BRIEF DESCRIPTION OF THE DRAWINGS

Various embodiments are depicted in the accompanying drawings for illustrative purposes, and should not be interpreted as limiting the scope of the inventions.

FIG. 1A is a block diagram illustrating an example embodiment of a merchandise return system.

FIG. 1B is a block diagram illustrating another example embodiment of a merchandise return system.

FIG. 2 is a block diagram of an example embodiment of a return authorization service.

FIG. 3 is an example embodiment of a dedicated point of return (POR) device.

FIG. 4 depicts a series of user interface screenshots for an example embodiment of a process for collecting data at a point of return.

FIG. 5 depicts an example embodiment of a fraud model architecture.

FIG. 6 depicts a set of factors that may be used to influence a determination made in connection with a requested merchandise return.

FIG. 7 is a flowchart that illustrates an example embodiment of a process for processing a merchandise return request.

FIG. 8 is a flowchart that illustrates an example embodiment of a process for processing a merchandise return request.

FIG. 9 is a flowchart that illustrates an example embodiment of a process for making determinations for a requested merchandise return

FIG. 10 is a flowchart that illustrates an example embodiment of a process for linking customer identifiers together

FIG. 11 is a flowchart that illustrates an example embodiment of a process for tracking consumers

FIG. 12 is a flowchart that illustrates an example embodiment of a process for making determinations based upon prior merchandise return data and prior sales data for a customer

### DETAILED DESCRIPTION OF THE PREFERRED EMBODIMENT

A merchant can utilize a complex return policy in order to limit abusive or fraudulent merchandise returns while also allowing legitimate merchandise returns to be made. If such a return policy is properly implemented and enforced, the merchant can limit exposure to some of the adverse consequences of merchandise returns, while enhancing customer good will and store reputation through a liberal return policy for legitimate returns. Unfortunately, the customer contact person for a store's return policy is frequently a lower-tier clerk, who may not be equipped to implement such a return policy or know how to use available information to help make the return authorization determination. Accordingly, an automated merchandise return processing system can be used to implement the merchant's return policy.

A computer-implemented return authorization system can make a determination of whether to accept or deny a requested merchandise return, and/or whether to issue a warning and restrict future returns for a consumer. These determinations can be made “behind the scenes” so that the clerk automatically receives a determination (e.g., accept, deny, or warn) in response to a submitted merchandise return request. In some embodiments, the clerk is not required to actively submit a merchandise return request. Rather, the clerk can simply processes the return (e.g., using a computerized point of return (POR) device), and the merchandise return processing system can interrupt the normal return transaction process if an adverse determination (e.g., deny or warn) is made. Thus, in some embodiments, for returns that are ultimately authorized, the fact that the return request was evaluated for abuse or fraud is not apparent to the consumer, or even to the clerk.

Concealing the involvement of the return authorization system can be advantageous because customers engaged in legitimate returns may be offended to learn that their legitimate return transactions are being scrutinized and/or tracked. Also, some consumers who engage in abusive or fraudulent returns carefully avoid locations where return requests are evaluated, and thereby avoid being identified. Thus, concealing the involvement of the return authorization system can lead to improved customer good will, improved detection of abusive or fraudulent returns, and increased deterrence of abusive or fraudulent returns since an abuser would not be able to reliably determine which merchants and locations are scrutinizing returns.

The determinations made for a requested merchandise return can be based, at least in part, on an assessment of the risk associated with the requested return. For example, in some embodiments, the risk assessment is implemented using a score calculation. When the consumer presents previously purchased merchandise for return, data about the requested return, about the consumer, and/or about a clerk processing the return may be entered into a POR device, and, based, at least in part, on the inputted data, a computer-calculated score or other computer-implemented assessment is generated to assess the likelihood that the requested return transaction is fraudulent or is abusive of the merchant's return policies. Acceptance of the returned items by the merchant may be based, at least in part, on the calculated score or other risk assessment.

To make the risk assessment for a requested merchandise return, the system can take into account not only the current return situation but also other related information (e.g., prior merchandise returns made by the consumer, prior purchases made by the consumer, or other customer data). In some embodiments, identification data for the consumer requesting the merchandise return can be collected by the clerk and/or by the POR device, and the identification data can be used for retrieval of stored data associated with the consumer (e.g., prior merchandise returns, prior purchases, address). The retrieved data can be used in assessing the risk associated with the requested return. Thus, in some embodiments, the clerk may ask for a customer's ID (e.g., driver's license) as part of the return transaction process. However, asking for a customer's ID may alert the customer that their merchandise returns are being scrutinized and/or tracked. As mentioned above, some legitimate consumers may be offended by the request for ID, and some abusers may avoid detection by merely avoiding locations that ask for ID. Thus, it can be advantageous to track a consumer's merchandise purchases, merchandise returns, and/or other customer data without asking a customer to provide their ID.

Embodiments of computer-implemented systems and methods are described that use customer identifiers extracted from sales data to track consumers. For example, as part of a merchandise return request, a consumer can provide a sales receipt that was generated when the consumer purchased the merchandise being returned. The sales receipt can have a transaction number or other receipt identifier that can be scanned or inputted (e.g., using a POR device). The receipt identifier can be used to retrieve the stored sales data associated with the transaction for the original purchase of the merchandise, and a customer identifier can be extracted from the sales data. The customer identifier can be, for example, a customer loyalty number, a hashed credit card number, a hashed debit card number, a hashed check account number, a merchant-specific customer number, a driver's license number, or any other identifier associated with the consumer who made the purchase that generated the sales data. The customer identifier can then be used to retrieve additional data (e.g., relating to previous purchases or returns) that is associated with the same extracted customer identifier, and the retrieved data can be used in assessing the risk associated with the requested return. Thus, the return authorization system can identify the consumer requesting the merchandise return and access data associated with that consumer in order to evaluate the consumer's riskiness without using the consumer's ID.

Although many of the example embodiments disclosed herein relate to the tracking of consumers for the purpose of processing merchandise returns, it will be understood that it can be advantageous to identify information (e.g., prior purchases, prior returns, or other customer data) associated with a particular consumer in other contexts as well, including but not limited to marketing and coupon selection.

In some embodiments, a coupon can be presented to a consumer when the consumer makes a merchandise return. The merchandise return can proceed as described above, except that the retrieved data is used to determine whether to present a coupon to the consumer and/or which coupon is to be presented. For example, if the data that was retrieved using the customer identifier extracted from the sales data associated with the presented receipt indicates that the consumer recently stopped purchasing products of a particular type from the merchant, the coupon can be offered for that type of product. The level of a customer's profitability can be determined from the past purchases data and past returns data, and the level of profitability can be used to influence whether or not a coupon is offered and/or the amount of the discount to be offered. More profitable customers can receive more significant discounts in an effort to ensure that profitable customers do not take their business elsewhere. Many variations are possible.

A coupon can be offered to a customer in connection with a merchandise purchase. If a customer makes a purchase using a credit card, or loyalty number, or otherwise makes a customer identifier available as part of the purchase transaction, that customer identifier can be used to retrieve stored information (e.g., prior purchases, prior returns, or other customer data) associated with the same customer identifier. The retrieved data can be used to determine whether to offer a coupon to the customer and/or to generate a coupon specially tailored to the customer. Additional information regarding coupon determinations is disclosed by U.S. Patent Publication No. 2008/0065485, filed Aug. 27, 2007, the entirety of which is hereby incorporated by reference. The tracked data can also be used in making marketing determinations, such as which advertisements to present to a particular consumer (e.g., on a video screen during the checkout or return process, or by mail, or on a website, etc.)

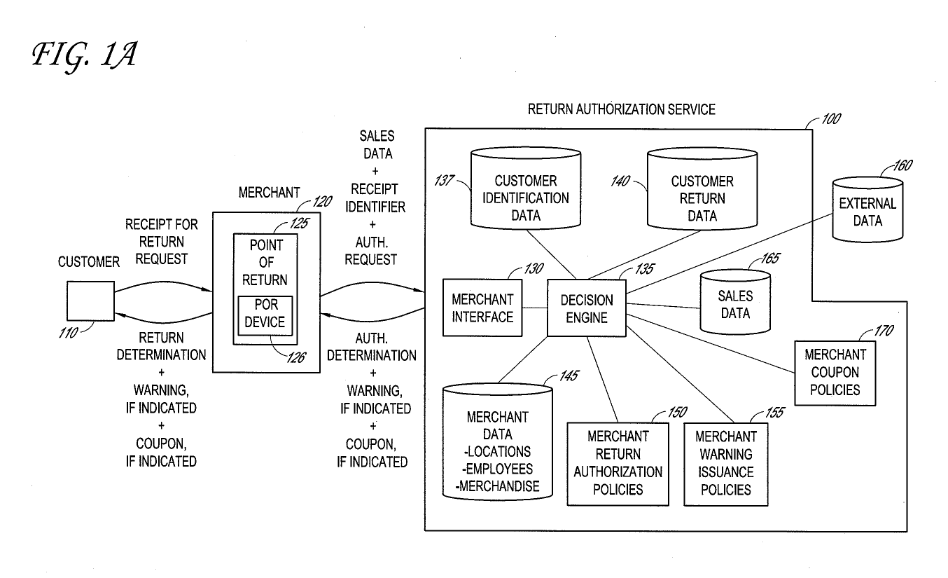

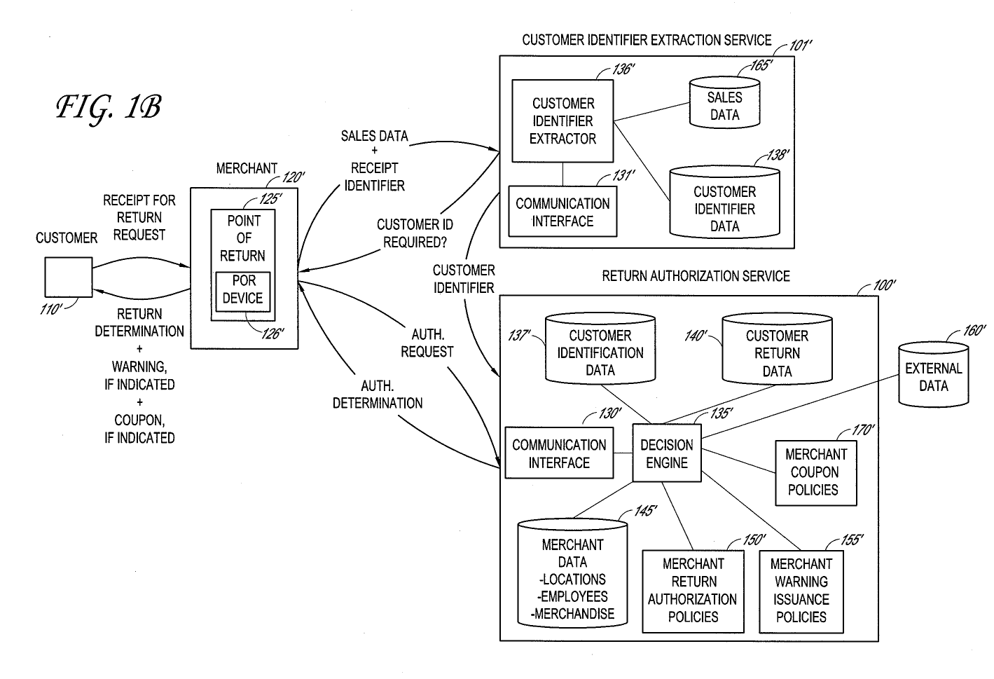

FIG. 1A is a block diagram depicting one embodiment of a merchandise return system. A customer 110 who wishes to return previously purchased merchandise can bring the merchandise to a point of return 125 at a merchant establishment 120 and can request to receive an equivalent dollar amount of cash, credit, merchandise, or some combination or equivalent thereof. The point of return 125 may be a desk or location within the merchant establishment 120 that is dedicated for processing merchandise returns. Alternatively, the point of return 125 may be a normal checkout terminal or cashier's station that may be additionally used for processing purchases and other types of business transactions, or the point of return 125 may be another location.

For purposes of this disclosure, the systems and methods described herein will frequently be described with reference to a clerk or other merchant employee who receives a merchandise return request from a customer 110 and who accepts or denies the return request, based, at least in part, on a recommendation received from one or more of the systems and methods described herein. In various embodiments, the actions attributed to the clerk may alternatively or additionally be carried out by another type of merchant employee or representative, or other person authorized to handle the merchandise return, or by an automated process or system configured to process the return request. Thus, while, for ease of description, the systems and methods will be described with reference to a clerk at a point of return 125, it should be understood that embodiments of the systems and methods may also be carried out with one or more of the above-listed, or other, clerk alternatives.

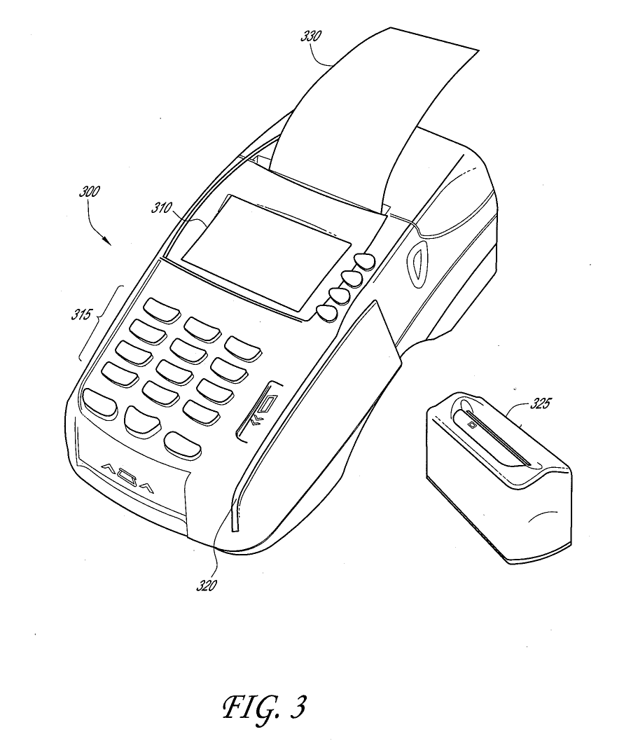

The clerk may use an automated point of return (POR) device 126 for processing the requested merchandise return. The POR device 126 may be used to input information about the requested return and to provide authorization information for the return to the clerk handling the return. In some embodiments, a device dedicated for use with merchandise returns may be used in association with the systems and methods described herein. One embodiment of such a dedicated POR device 126 is described with reference to FIG. 3 below. In other embodiments, the POR device 126 is at least one of: a hand-held device, a wireless device, a telephone-assisted device, a self-serve kiosk, an assisted-return kiosk, or other suitable apparatus. In some embodiments, rather than using a dedicated POR device 126, a multi-functional check-out terminal or other computerized device may be configured to provide some or all of the functionality associated with the POR device 126 described herein. In some embodiments, more than one device may be used to provide some or all of the functionality described herein for the POR device 126. Thus, while the systems and methods described herein may be described with reference to a dedicated POR device 126, it is to be understood that a wide variety of dedicated and/or multi-purpose POR devices 126 may be used without departing from the spirit of the invention as described herein.

In some embodiments, merchants 120 can have a return policy that outlines conditions for accepting returned merchandise. For example, the merchant 120 may stipulate that the customer 110 must has a receipt associated with purchase of the item to be returned, that the return take place no more than thirty days after the purchase date, that the item be in its original packaging and/or has not been used, and so forth.

Merchants 120 may implement this or any of a wide variety of other return policies to suit their business goals. For example, merchants 120 may implement different return policies for different classes of items, stipulating, for example, that software merchandise returns must still be in their original, unopened packaging, while returns of other types of products may be accepted, even with opened packaging. In accordance with some merchant return policies, certain types of merchandise are not accepted for return. As another example, a merchant 120 may desire to implement a more liberal return policy during the post-holiday season when the point of return 125 counters experience a higher-than-normal volume of returns. Based at least in large part on the return policy used by the merchant 120, a clerk, or other person or process, at the point of return 125 may accept or deny the customer's 110 returned merchandise.

As depicted in FIG. 1A, the authorization determination for the customer's requested return may be handled by an automated return authorization service 100. The return authorization service 100 may accept information input by the clerk at the point of return 125 and use various types of information associated with the requested return in order to implement the merchant's 120 return policy and to assess risk of exposure to fraudulent, abusive, or unprofitable behavior that may be associated with accepting the requested return.

In some embodiments, the return authorization service 100 may be implemented, as depicted in FIG. 1A, as an external entity whose services are contracted or otherwise provided to the merchant 120. Additionally or alternatively, the return authorization service 100 may be implemented as one or more software and/or hardware components under the operation of the merchant 120 that function in the POR device 126 and/or within one or more computer devices at the point of return 125, at another location within the same physical merchant establishment and/or at a geographically removed location used by the merchant 120. Thus, although the systems and methods described herein are most often described in association with an external return authorization service, it is to be understood that any combination of these or other implementation arrangements may be used.

In embodiments where the return authorization service 100 is a separate entity that assesses and authorizes requested returns presented to the merchant 120, communication between the merchant's point of return 125 and the return authorization service 100 may be carried out using any of a wide variety of appropriate devices and/or communications and data security technologies. For example, the communications between a computerized device at the merchant's point of return 125 and a merchant interface 130 at the return authorization service 100 may be carried out using the Internet or other global network. In other embodiments, the communications may be carried out using any communication system including by way of example, dedicated communication lines, telephone networks, wireless data transmission systems, two-way cable systems, customized computer networks, interactive kiosk networks, automatic teller machine-type networks, interactive television networks, and the like.

The customer 110 requesting the merchandise return presents a receipt to the clerk. The clerk can scan the receipt or otherwise input a receipt identifier taken from the receipt. The receipt identifier can include, for example, the date, a store number, a transaction number, a register number, some combination thereof, or some other identifier capable of identifying the transaction associated with the receipt. The clerk handling the requested return can use the POR device 126 to input and send information about an authorization request to the return authorization service 100. The receipt identifier can be sent to the return authorization service 100 as part of the authorization request or separately. The return authorization service 100 can receive the information from the POR device 126 via the merchant interface 130 and uses the information, together with other stored information, to make an authorization determination for the requested merchandise return, assessing the risk of accepting the return and implementing merchant return policy preferences to recommend either that the clerk accept the requested return, refuse to accept the requested return, or take another course of action.

In some embodiments, as will be described in greater detail below, the return authorization service 100 may provide a warning to the customer 110 together with a positive authorization determination, indicating that although the current return request is being accepted, authorization of future return requests from the customer may be limited. Also, in some embodiments, the return authorization service 100 may provide a coupon for the customer 110 together with a positive authorization determination.

As another example, in accordance with some store policies, as an alternative to accepting the requested return, the authorization service 100 may provide an authorization determination recommending that the clerk offer store credit or some other alternative in place of a requested cash exchange for the cash value of the returned merchandise. In some embodiments, the authorization service 100 may also provide a recommended timing for paying the consumer. For example, the authorization service 100 may recommend mailing a check to cover the return amount, crediting an account in the future, implementing a cooling-off period, requiring further review before authorization, or the like.

The embodiment of the return authorization service 100 that is depicted in FIG. 1A includes a merchant interface 130, a decision engine 135, a customer identification data repository 137, a customer return data repository 140, a merchant data repository 145, a repository of merchant return authorization policies 150, a repository of merchant warning issuance policies 155, a sales data repository 165, and a repository of merchant coupon policies 170. Other embodiments of the return authorization service 100 may include other components and/or a subset of these components. For example, some embodiments may include only the decision engine 135 and may access information from other sources, and some embodiments may omit components shown in FIG. 1A such as the repository of merchant coupon policies 170, or others. Additionally, some components shown in FIG. 1A may be divided into multiple components, or combined together. For example, the decision engine 135 can be used to make the authorization determinations, warning determinations, and coupon determinations, or multiple decision engines can be used. Also, a single database can include some or all of the data repositories shown in FIG. 1A, or multiple databases can be used.

The merchant interface 130 can receive sales data from the merchant 120 and store the sales data in the sales data repository 165. The sales data can be sent periodically or intermittently to the merchant interface 130. For example, the merchant 120 can transfer a batch of sales data to the merchant interface 130 once each day (e.g., after the store closes), once every two days, once each week, twice each day, once each hour, or at any other suitable frequency. In some embodiments, the sales data can be sent to the merchant interface 130 on a per-transaction basis with little or no delay after the purchase transaction. If a customer 110 tries to return the purchased merchandise shortly after making the purchase, and before the sales data is received into the sales data repository 165, the return authorization service 100 would not be able to access the sales data to extract a customer identifier, access the appropriate customer data, and assess the riskiness of the requested return. Thus, it can be advantageous for the sales data repository 165 to receive the sales data a soon as possible after the purchase transaction occurs. The sales data transferred to the merchant interface 130 can include all the sales transactions made by the merchant 120 during the applicable period (e.g., each day), or some transactions may be excluded so that the sales data includes only a subset of the sales transactions. The merchant interface 130 and/or the point of sale devices or other computer systems at the merchant 120 can be configured to transfer the sales data automatically without any user involvement. Alternatively, the review and/or approval of a manager at the merchant 120 may be required before a batch of sales data is transferred to the merchant interface 130. Many variations are possible.

The merchant interface 130 can receive an authorization request from the merchant POR device 126, information about the requested merchandise return sent from the POR device 126, and a receipt identifier sent from the POR device 126. In some embodiments, the information about the requested merchandise return and/or the receipt identifier can be transferred as part of the authorization request or as separate data transfers. The received information is sent to a decision engine 135 for assessing risk associated with accepting the requested merchandise return and for making an authorization determination that is based on the assessed risk as well as on stored information about the merchant's return authorization policies 150. The return policy 150 may be implemented in a variety of computer-usable forms, including, but not limited to, rule-based systems, decision trees, scorecard systems, and the like. In various embodiments, the decision engine 135 may assess the requested return transaction with reference to one or more threshold conditions, such as an acceptable score. In some score-based embodiments, in which a high score indicates low risk, if the requested return transaction meets or exceeds an authorization threshold, the return is accepted, while if the requested return does not meet the threshold, the return is denied. Other methods of assessing whether to accept the requested return may alternatively or additionally be used.

The decision engine 135 may also use stored information about the merchant's warning issuance policies 155, if available, to determine if a warning is to be issued to the customer. The warning policy 155 may also be implemented in a variety of computer-usable forms, including, but not limited to, rule-based systems, decision trees, scorecard systems, and the like. In some embodiments in which assessment is carried out by a scoring system, in which a lower score indicates higher risk, the decision engine 135 can determine that the return transaction has a high enough safety score for the return to be authorized, but that the safety score only exceeded the denial threshold by a small margin, indicating that the customer may be close to crossing the line into abusive or fraudulent return behavior. The decision engine can then prepare an appropriate warning and/or restriction to issue to the customer. In some embodiments, a return request score can fall into one of three categories: authorize, warn, and deny. A return request that falls below the denial threshold can be denied. For a return request that falls between the denial threshold and the authorization threshold, a warning to the customer 110 may be issued along with an acceptance, alerting the customer 110 that acceptance of future returns may be limited, based on additional return activity. A return request that exceeds an authorization threshold can be authorized with no warnings or restrictions. In some embodiments, multiple warning thresholds can be used to determine which of several warnings (if any) should be issued to the customer.

The decision engine 135 may also use stored information about the merchant's coupon issuance policies 170, if available, to determine if a coupon is to be offered to the customer. The coupon policies 170 may also be implemented in a variety of computer-usable forms, including, but not limited to, rule-based systems, decision trees, scorecard systems, and the like. In some embodiments in which assessment is carried out by a scoring system, in which a lower score indicates higher risk, when the decision engine 135 determines that the return transaction has exceeded a coupon threshold, a coupon can be offered to the customer 110. In some embodiments, multiple coupon thresholds can be used to determine which of several coupons (if any) should be issued to the customer. Sometimes a customer returns an item because they are dissatisfied with the merchandise or with the merchant 120, and a coupon offering may appease the customer and further increase the merchant's 120 good will and reputation. In some embodiments, the coupon offer determination can be based the same scoring algorithm as the return authorization determination, or on a different scoring algorithm.

In addition to stored information about the merchant's return policies 150, warning policies 155, and coupon policies 170, the decision engine 135 may make determinations based, at least in part, on information from one or more other repositories of data collected and maintained by the return authorization service 100, or from one or more external merchant or non-merchant data sources 160. For example, the decision engine 135 may identify the customer 110 requesting the merchandise return, identify customer data associated with the customer 110 (e.g., prior returns and/or prior purchases made by the customer 110), and make a risk assessment, or other determinations, based at least in part on the identified customer data.

In some embodiments, the decision engine 135 can identify the customer 110 by using the received receipt identifier, without having the customer 110 present a form of ID. As mentioned above, the merchant interface 130 can receive the receipt identifier for the receipt associated with the purchase of the merchandise being returned. The decision engine 135 can use the receipt identifier to locate the sales data from the original purchase of the merchandise in the sales data repository 165. The decision engine 135 can extract a customer identifier from the located sales data. The customer identifier can be, for example, a customer loyalty number, a hashed credit card number, a hashed debit card number, a hashed check account number, a credit card number, a debit card number, a check account number, a merchant-specific customer number, a driver's license number, an address, or any other identifier associated with the consumer who made the purchase that generated the sales data. In some embodiments, the customer identifier can be unique to an individual consumer (e.g., a driver's license number), or it can be a customer identifier shared by a multiple consumers. For example, a single credit card number may be shared by multiple members of a single family, and the multiple family members may be tracked as a single customer for purposes of the risk assessment and/or other determinations made by the decision engine 135.

The decision engine 135 may access information stored in a repository of customer identification data 137. The repository of customer identification data 137 may store information about a large number of customers, including, for example, information about customer names, addresses, identification numbers, such as driver's license and other identification numbers, biometric identification information, and the like. This information may be used in an effort to positively identify the customer 110. This information can also be used directly in the risk assessment, or other determinations. For example, a customer's 110 address may be an indicator that the requested merchandise return is fraudulent if previous fraudulent returns were made in connection with that address.

In some embodiments, the customer identification data 137 can include stored associations or links between various customer identifiers. For example, if a customer 110 makes a purchase using a first credit card and a customer loyalty card, and then later makes a purchase using a second credit card and the same customer loyalty card, each of the first credit card number, second credit card number, and customer loyalty number can be associated together as representing a single customer. Thus, if the customer later makes a return of merchandise purchased using the first credit card, without the loyalty card, the decision engine 135 will be able to locate and evaluate not only prior purchases and returns made using the first credit card, but also those made using the second credit card or using the customer loyalty card. Many variations are possible.

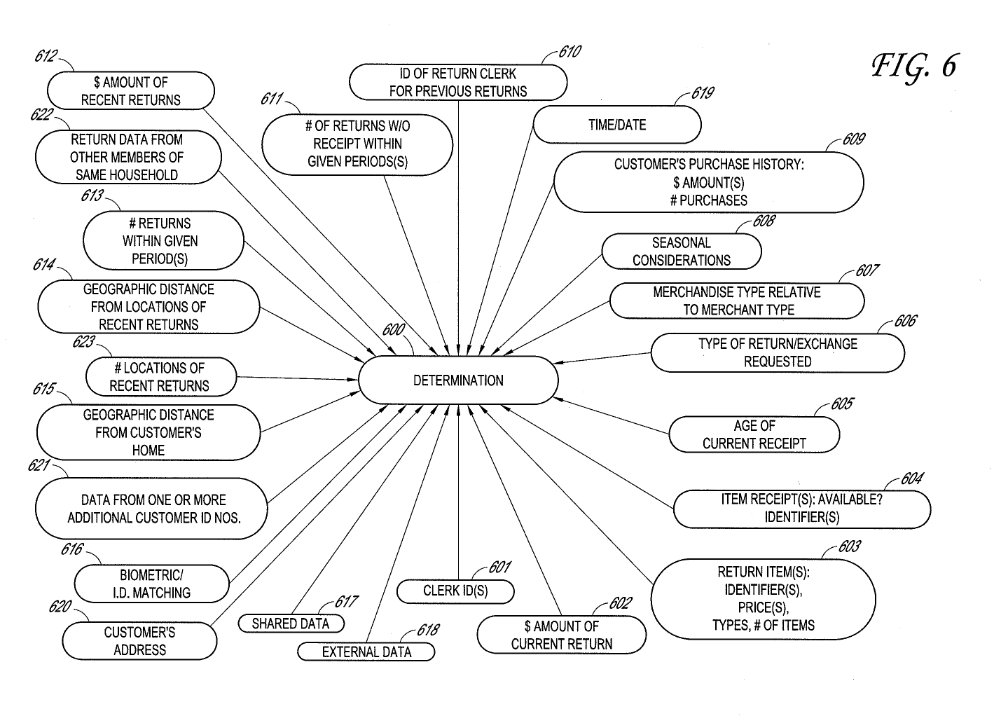

The decision engine 135 may use information from a repository of customer return data 140, which includes a wide variety of information about past merchandise return activity associated with the customers 110. The decision engine 135 may also used information from the repository of sales data 165, which includes a wide variety of information about past purchases associated with the customers 110. Some examples of information associated with past purchase and return transactions are described in greater detail with reference to FIG. 6 below. Using the customer identification data 137, the customer return data 140, and the sales data 165, allows the decision engine 135 to link information about past merchandise purchases and returns with the customer 110 requesting the return at the point of return 125.

The decision engine 135 may base the risk assessment, or other determinations, based at least in part on stored merchant data 145 that may include any of a wide variety of types of information associated with the merchant 120, including, but not limited to: information about the location(s) of the merchant's 120 stores or other establishments, information about the merchant's 120 employees (including names, identification numbers, hire dates, home addresses, past association with proper, fraudulent, and/or questionable merchandise returns, and the like), and information about the merchant's 120 inventory of merchandise.

In some embodiments, a “negative file,” such as a listing of customers 110 who are known to have been involved with past fraudulent returns or past criminal activity, may be maintained and used to make return authorization determinations. In some embodiments, one or more “positive files” may be kept that list customers who may be accorded special treatment by the return authorization service. For example, one or more positive files may be maintained to list customers known to be profitable to the merchant and/or customers in the fashion industry, or other categories of customers, who may be accorded special return privileges. Such positive files may be used to make risk assessments or other determinations.

Furthermore, the decision engine 135 may additionally or alternatively access and make use of information stored in data repositories that are external to the return authorization service 100. External data sources 160 may be used to access information such as, for example: customer and/or employee identification information, address information including postal box information, credit data, shoplifting data, crime data, identification theft data, sales tax data, or any of a wide variety of other useful information types. Such external data 160 may be accessed externally on an as-needed basis and/or may be stored by the return authorization service 100 for subsequent use.

The functions of the decision engine 135 may be carried out in any of a wide variety of suitable, computer-implemented forms, such as a decision tree, an expert system, or other ruled-based decision system, as a linear calculation or other scoring mechanism, or as a form of probabilistic or neural network, genetic, or other statistical model or algorithm for decision-making. A more detailed description of factors that may be used by the decision engine 135 to make a return authorization determination and/or to determine whether to issue a warning and/or to determine whether to offer a coupon will be provided with reference to FIG. 6 below.

For ease of description, the return authorization service 100 as depicted thus far in the disclosure and with reference to FIG. 1A has been described as providing merchandise return authorizations and other related services to a single merchant 120. However, it is to be understood that, in practice, it is much more common for the return authorization service 100 to serve a plurality of merchants 120. When the return authorization service 100 serves a plurality of merchants 120, it may maintain an associated plurality of data stores, including, but not limited to: the customer return data repository 140, the merchant data repository 145, the merchant return authorization policies 150, the merchant warning issuance policies 155, the merchant coupon issuance policies 170, and sales data 165 for each of the merchants 120 for whom it provides return authorization services. The return authorization service 100 may maintain these data stores separately, either logically and/or physically. Furthermore, the return authorization service 100 may combine some or all of the various data stores described above.

In some embodiments, agreements may be implemented allowing merchants to share their collected data for risk assessment or return authorization purposes or other determinations. In some embodiments, data collected from various merchants may be maintained separated, logically and/or physically. Thus, if a customer 110 makes a return request at a particular merchant, the authorization determination may be based only on data collected in connection with that particular merchant (e.g., prior purchases and returns made with the particular merchant), or it can be based on data collected from various merchants.

Although a wide variety of embodiments exist, for ease of description in this disclosure, it will be assumed that the embodiments of the return authorization service 100 described herein maintain data received from different merchants 120 separately, and do not use data received from one merchant to make an authorization return determination for another merchant. In other embodiments, however, modifications may be made to the systems and methods described herein such that the systems and methods may store data from a plurality of merchants together and/or may use data from one merchant in a return authorization request from another merchant. Furthermore, data from external third-party data providers, such as government information sources, credit bureaus, police information sources, and the like may be used by the return authorization service 100 to make determinations for the merchant 120.

Once the decision engine 135 has made an authorization determination for the requested return, the merchant interface 130 may send a message to the point of return device 126, informing the clerk of the determination. In some embodiments, the point of return device 126 may then print a record of the requested return, indicating that the return has been accepted or denied. The record may include associated explanations, and, in some embodiments, a warning about limitations on the acceptance of future merchandise returns from the customer 110. In some embodiments, the record may include a coupon or other offer for the customer.

The return authorization service 100 and included modules 130, 135, 137, 140, 145, 150, 155, 165, and 170 as depicted in FIG. 1A, are one embodiment of a return authorization service 100 in connection with the systems and methods described herein. It is to be understood that in other embodiments, the structures and functions of these modules may be implemented in a wide variety of different configurations. For example, some or all of the data storage functions, the decision-making functions, the communications functions, and the like, may be provided by external third-party service providers, may be implemented at one or more merchant locations, including within the POR device 126, and/or may be implemented differently using different internal structures. Furthermore, although the return authorization service 100 is depicted in FIG. 1A as being a single entity located at a single location, it is to be understood that in other embodiments, the structures and functions of the return authorizations service 100 may be implemented in total or in part by a distributed system of hardware and software that may be located at two or more physically distinct locations.

For example, FIG. 1B is a block diagram depicting an alternative embodiment of a merchandise return system, which can be similar to, or the same as, the merchandise return system of FIG. 1A in many regards. Components of FIG. 1B that have corresponding components discussed above in connection with FIG. 1A are shown using the same reference numerals used in FIG. 1A except having an apostrophe added thereto. Much of the written disclosure for FIG. 1A also applies to FIG. 1B and will not specifically repeated.

The merchandise return system of FIG. 1B can include a customer identifier extraction service 101′ and a return authorization service 101′. The customer identifier extraction service 101′ can be configured to receive sales data and a receipt identifier for a requested return, identify sales data associated with the receipt identifier, extract a customer identifier from the identified sales data, and transfer the customer identifier to the return authorization service 100′. The return authorization service 100′ can be configured to receive an authorization request and a customer identifier, make a return authorization determination (or other related determinations), and communicate the determination(s) to the merchant 120′.

Communication between the merchant 120′, the customer identifier extraction service 101′, and/or the return authorization service 100′ may be carried out using any of a wide variety of appropriate devices and/or communications and data security technologies such as using the Internet or other global network. In other embodiments, the communications may be carried out using any communication system including by way of example, dedicated communication lines, telephone networks, wireless data transmission systems, two-way cable systems, customized computer networks, interactive kiosk networks, automatic teller machine-type networks, interactive television networks, and the like.

The extraction service 101′ and a return authorization service 101′ can be implemented as separate entities whose services are contracted or otherwise provided to the merchant 120′. In some embodiments, the customer identifier extraction service 101′ can be implemented as one or more software and/or hardware components under the operation of the merchant 120 that function in the POR device 126 and/or within one or more computer devices at the point of return 125, at another location within the same physical merchant establishment and/or at a geographically removed location used by the merchant 120.

The customer identifier extraction service 101′ can include a communication interface 131′, a customer identifier extractor 136′, a sales data repository 165′, and a customer identifier data repository 138′. Sales data can be transferred from a merchant 120′ to the communication interface 131′ and stored in the sales data repository 165′. When a customer 110′ presents merchandise to be returned, the clerk at the merchant point of return 125′ may receive a receipt from the customer 110′ and input (e.g., scan) a receipt identifier from the receipt (e.g., using a POR device 126′). The receipt identifier can be sent to the customer identifier extraction service via the communication interface 131′.

The customer identifier extractor 136′ can use the receipt identifier to identify the sales data in the repository 165′ that is associated with the original purchase of the merchandise being returned. The customer identifier extractor 136′ can then extract a customer identifier from the identified sales data. In some embodiments, the customer identifier data repository 138′ can include stored associations or links between various customer identifiers, to tie various customer identifiers to a single customer, as described above. In some embodiments, the communication interface 131′ can send a single customer identifier to the return authorization service 100′, or a list of customer identifiers can be sent so that the return authorization service 100′ can access a more complete set of data in connection with the requested return. If the customer identifier extractor 136′ is unable to extract a customer identifier, a notification can be communicated to the merchant 120′ to request a form of ID (e.g., driver's license) from the customer 110′.

The return authorization service 100′ can include a communication interface 130′ configured to communicate with the merchant 120′ and/or with the customer identifier extraction service 101′. A decision engine 135′ can make risk assessments, or return authorization determinations, or other determinations similarly as described above. The decision engine 135′ can make assessments and determinations based on merchant return authorization policies 150′, merchant warning issuance policies 155′, merchant coupon issuance policies 170′; merchant data 145′, customer return data 140′, customer identification data 137′, and/or external data 160′ in manners similar to those described in connection with FIG. 1A. In some embodiments, the customer identifier extraction service 101′ can compile a summary of the relevant sales data (e.g., relating to prior purchases associated with the extracted customer identifier(s)) and send the summary to the return authorization service 100′ for use in making determination(s). Thus, in some embodiments, the return authorization service 100′ can consider prior purchases made by customers 110 without directly storing the merchant's 120′ sales data. This can be advantageous, for example, in embodiments in which the customer identifier extraction service 101′ is under control of the merchant 120′ and the merchant 120′ is not willing to allow outside entities direct access to its sales data 165′. In some embodiments, the return authorization service 100′ can have direct access to the sales data 165′ for use in making determination(s).

The return authorization, or other determination(s), can be transferred to the merchant 120′ using the communication interface 130′, for example, as a message to the POR device 126′. The clerk or POR device 126′ can inform the customer of the return authorization decision, can issue a warning to the consumer, and/or can offer a coupon or other offer to the consumer, as dictated by the determination(s) made by the return authorization service 100′.

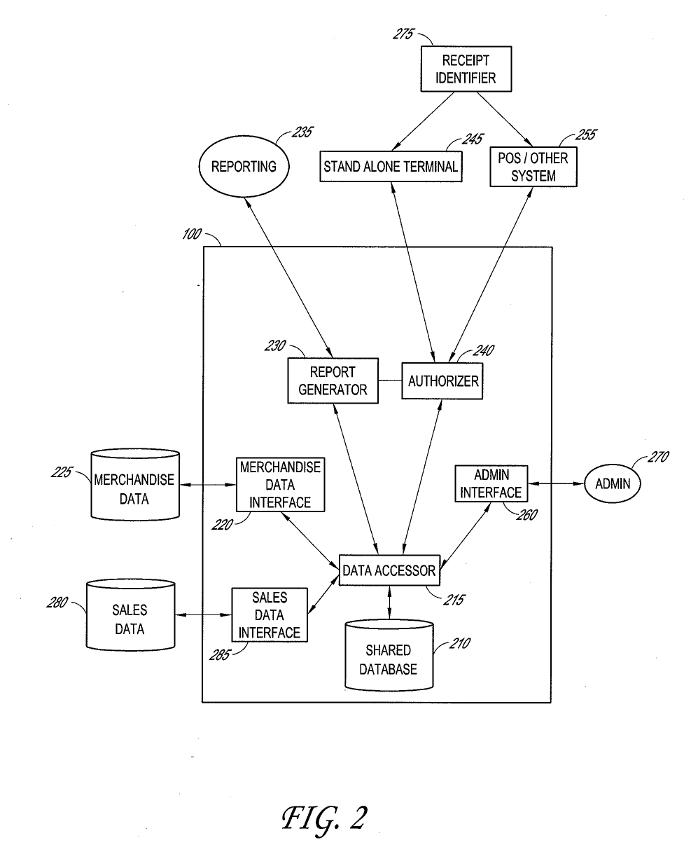

FIG. 2 is a block diagram depicting a closer view of one embodiment of a return authorization service 100 that provides a variety of services to the merchant 120. As depicted in FIG. 2, the various repositories of data used by the return authorization service 100 are combined conceptually as a single shared database 210. As described with reference to FIG. 1A, the data stored for use by the return authorization service 100 may be stored and maintained as a single or a plurality of data repositories.

The data in the shared database 210 is managed by a data accessor 215 that receives data for storage in the shared database 210 from a variety of sources and that receives requests for data from the shared database 210 for a variety of purposes. In various embodiments, the data accessor 215 may manage the various types of data using any of a variety of computer-implemented platforms suitable for such purposes, including, but not limited to, DB2, Oracle, or other SQL-based systems.

As depicted in FIG. 2, merchandise data 225 from a merchant 120 may be sent to a merchandise data interface 220 of the return authorization service 100 for storage in the shared database 210 by the data accessor 215. Sales data 280 can be sent to a sales data interface 285 for storage in the shared database 210 by the data accessor 215. Merchant administrators 270 may use an administrative interface 260 of the return authorization service to send and receive data to the data accessor 215.

The data accessor 215 may further provide data to a report generator 230 that provides reporting services 235 to the merchant 120. Examples of data reported for a given period may include, for example: total number of returns, total number of items returned, total dollar value returned, total number of requested returns denied, identification of customers whose returns were denied, return statistics by store branch, identification of customers who engage in a high volume of returns, or who have a high ratio of returns to purchases, and the like. Reports for merchants may include daily transaction reports, as well as longer term reports for loss prevention analysis. In some embodiments, the reports can be used to evaluate the efficacy of the merchant's 120 current return authorization policies and make modifications and improvements to the policies.

In some embodiments, reports may also be made available to customers 110, and especially to customers whose return requests have been denied, or who have received a return-related warning. The customers may wish to know what information is stored about their merchandise purchase and/or return activity, including, for example, store(s) returned to, any authorizations and denials, and dates and dollar amounts of requested return(s).

An authorizer module 240, which may comprise, for example, the decision engine 135 that is described with reference to FIG. 1A, provides return authorization determinations and/or other determinations (e.g., regarding the issuance of warnings or offering of coupons). As depicted in the embodiment shown in FIG. 2, the authorizer 240 may communicate directly with a stand-alone terminal 245 that is dedicated for point of return use. The authorizer 240 can be configured to communicate with a point of sale (POS) or other system 255 used by the merchant to process merchandise returns and to communicate with the return authorization service 100.

The stand alone terminal 245 and/or the POS or other system 255 can be used to transfer a receipt identifier 275 to the authorizer 240. As described above, the receipt identifier 275 can be used by the authorizer 240 to identify the sales data associated with the purchase of the merchandise being returned, extract one or more customer identifiers from the sales data, and access customer data (e.g., prior purchases or returns) associated with the extracted customer identifiers.

In various embodiments, transfer of some or all of the data into and out from the return authorization service 100 may be implemented, for example, using FTP transfer protocols. For protection of consumer privacy and merchant business information, the data is preferably transferred into and out from the return authorization service 100 in an encrypted form, for example using PGP (Pretty Good Privacy) or other suitable encryption technology.

The functions and/or components of the return authorization service 100 described with reference to FIG. 2 may be implemented, in some embodiments, as a plurality of servers operating as a server farm under the management of any of a variety of clustering technologies. Such an arrangement typically allows for relatively seamless replacement of components as well as upgrades and additions to the system as transaction volume increases.

Furthermore, the functions and/or various modules of the return authorization service 100 may be implemented in various embodiments using personal computers (PCs), workstations, other processors, program logic, or other substrate configurations representing data and instructions, which operate as described herein. In various embodiments, the processors may comprise controller circuitry, processor circuitry, processors, general purpose single-chip or multi-chip microprocessors, digital signal processors, embedded microprocessors, microcontrollers and the like.

FIG. 3 depicts one embodiment of a dedicated point of return (POR) device 300 for use in processing merchandise returns. The POR device 300 can be configured to use a telephone dial-up connection or network cable connection to communicate with the return authorization service 100. In other embodiments, one or more other wired or wireless communications systems are used for communicating with the return authorization service 100. In some embodiments, some or all of the functions provided by the return authorization service 100 may be provided by components that are internal to the POR device 300.

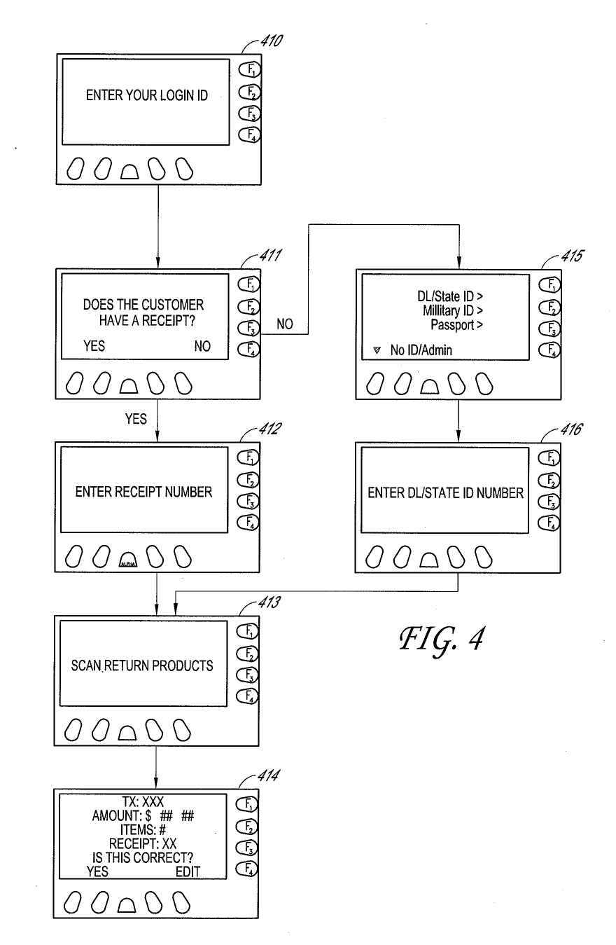

As depicted in FIG. 3, the POR device 300 includes a display screen 310 for communicating visually with a clerk or other person handling the requested return transaction. Examples of communications that may be presented on the display screen 310 are described with reference to FIG. 4 below. In other embodiments, the POR device 300 may include audio speakers, video display, or any of a wide variety of other communications technologies for communicating information to the clerk.

The POR device 300 also includes a keyboard 315 with a plurality of buttons that allow the clerk to input information to the POR device 300. Additionally, other buttons and input systems in other parts of the POR device 300 also allow the clerk to input information to the POR device 300. In other embodiments, any of a wide variety of other input systems, such as voice recognition systems, keyboards, touch screen systems, camera or video systems, biometric systems, and the like, may be used additionally or alternatively for allowing the clerk to input information into the POR device 300. Furthermore, other forms of electronic reading devices, including, but not limited to, 1-dimensional, 2-dimensional, or 3-dimensional barcode scanners, magnetic stripe readers, readers for other electronically-readable codes, RFID readers, any of a wide variety of biometric data input devices, and the like, may be used to input data to the POR device 300. For example, the POR device 300 depicted in FIG. 3 includes a built-in magnetic stripe reader 320 for scanning identification cards, credit cards, and the like that include a magnetic stripe, and a peripheral 2-dimensional bar code scanner 325 for reading cards or other items provided with a 2-dimensional barcode. Other peripherals for inputting data about a wide variety of other identification and informational sources may also be used.

As shown in FIG. 3, the POR device 300 may be configured to produce a paper receipt 330 or other record of the merchandise return transaction for the customer 110 and/or for the clerk on behalf of the merchant 120. In other embodiments, a record of the transaction may be provided to the customer 110 using email or other electronic communications technology. Where the customer 110 is requested to sign a record of the return transaction, the POR device 300 may include a system for electronically capturing the signature or other form of customer acknowledgement. In some embodiments, an indication of a warning provided to the customer 110 at the point of return 125 is printed, or otherwise displayed, on the receipt 330, on the display 310, or on a separately printed paper. In some embodiments, a coupon or other offer for the customer 110 is printed, or otherwise displayed, on the receipt 330, on the display 310, or on a separately printed paper.

As described above, the functions of the POR device 300 may additionally or alternatively be provided by other types of electronic devices, such as a suitably programmed and configured point of sale (POS) terminal, cash register terminal, or other device that may process merchandise returns as well as other types of transactions and that may use technologies such as biometrics, bar-code readers, and the like. FIG. 4 depicts a series of sample user interface screenshots 410-416 for one embodiment of a process for collecting data at a point of return 125. The screenshots 410-416 depicted in FIG. 4 exemplify screenshots that may be presented on a display screen 310 of a POR device 300 such as the one depicted in FIG. 3. The screen shots 410-416 represent prompts to the clerk to input information associated with the requested merchandise return so that a return authorization determination may be made for the requested return.

In screenshot 410, the clerk is prompted to enter a login ID or other employee identification number used to identify the clerk processing the return. In some embodiments, a password is required to prevent a clerk from entering an inaccurate login ID. In screenshot 411, the clerk is prompted to enter whether the customer 110 has a receipt for the items being returned. If the customer does have a receipt, screenshot 412 prompts the clerk to enter the receipt number. The receipt number can be entered using the key pad 315 or read from a barcode on the receipt using the scanner 325. In screenshot 413, the clerk is prompted to scan the products being returned. A bar code on the products can be scanned using the scanner 325, or alternatively, the clerk can user the keypad 315 to enter a Stock Keeping Unit code (SKU), a Universal Product Code (UPC), or other number that identifies the products being returned.

In screenshot 414, the clerk is presented with a summary of the inputted transaction information. The return transaction can be assigned an identification number, as shown in screenshot 414. The clerk can be prompted to verify that certain information (e.g., the exchange dollar amount and number of items) is correct. The clerk may also be prompted to verify whether a purchase receipt has been provided with the return request. The clerk provides an input indicating either that the information is correct or that the information needs to be edited.

If the customer does not have a receipt for the return, the clerk may be presented with screenshot 415, which prompts the clerk to indicate which kind (if any) of identification verification the customer 110 is providing. In Screenshot 416, assuming that the clerk indicates that the customer 110 is presenting a driver's license or other state identification card, the clerk is now prompted to input the driver's license number or state identification card number. As was discussed above, this information may be keyed in, read electronically from a magnetic stripe, barcode, or other smart card reader, or input using any of a wide variety of other input technologies.

Furthermore, in various embodiments, if desired, the POR device 126 may be configured to alternatively or additionally accept input about other types of identification, such as other types of U.S. government-issued identification numbers, or Canadian or Mexican identification numbers. Examples of identification that may be used, alone or in combination with one another, include, but are not limited to numbers, identifiers or other data associated with: student identification, military identification, passport, voter registration card, Immigration and Naturalization Service documents (such as a green card or laser visa), consular identifications (matricula consular and others), loyalty card, gift card, coupon, merchandise credit slip, receipt authorization code, checking account, receipt date or other combination of receipt data identifiers, name, address (current and/or past), data of birth, phone number, SSN, credit card, debit card, biometrics (photo, face, fingerprint, voice, DNA, retinal), employer identification number, digital image of the customer obtained from license, customer birth date and/or age, driver's license expiration date, security system number, and many other types of accounts and identifiers.

Once the customer ID has been entered, the clerk can be presented with screenshot 413 as described above. The screenshots of FIG. 4 have been provided as an example of a POR device 126 user interface interaction for inputting information about a requested merchandise return. As will be familiar to one of skill in the art, a wide array of variations may exist in the exact methods used to obtain information about the requested return at the point of return 125. The content and order of screenshot displays, for example, may be different than those depicted in FIG. 4, and, in fact, the clerk may be expected to input the relevant data in response to an interactive voice response (IVR) system or without the use of prompts at all. In some embodiments, the POR device 126 may be configured to allow for the collection of some or all of the following additional information: retailer identification, consumer name and address, customer zip code, current price of the returned items, product condition, customer's stated reason for making the return, purchase date, time, tender type, and original salesperson, ID expiration date, requested return type (e.g., cash exchange, credit to account, even exchange for merchandise, or merchandise exchange with balance due either to the merchant or to the customer), as well as other types of information.

Furthermore, the POR device 126 may preferably be configured to automatically transmit some additional information to the return authorization service 100 with the request for authorization determination. For example, an identifier associated with the POR device 126 may be transmitted to the return authorization service 100 and may be used to identify the merchant 120, the store branch or other location at which the point of return device 126 is located, as well as the date and local time of the requested return transaction, and the like.

As will be described with reference to FIG. 6, in various embodiments, the determination whether to authorize a requested return, and, similarly, whether to issue a warning or coupon along with an authorization approval, may depend on a wide variety of factors, some of which may involve the input of data at the point of return 125. Accordingly, the series of prompts that are displayed to the clerk may be adjusted to prompt for data appropriate to the given embodiment.

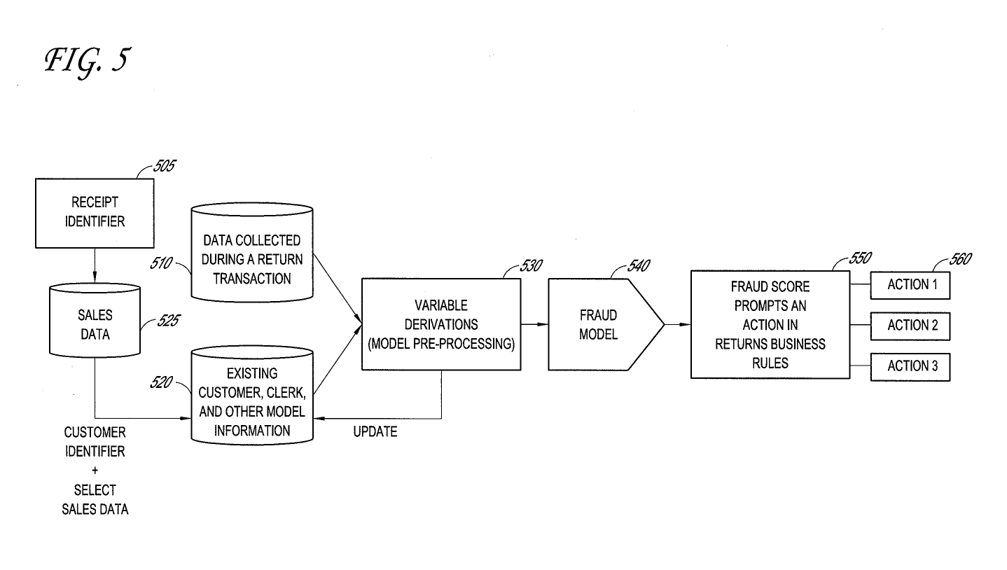

FIG. 5 depicts one embodiment of a fraud model architecture that may be used to implement one or more statistical models used by the decision engine 135 of the return authorization service 100. In various embodiments, the statistical models accept information available at the time of a merchandise return transaction and provide an outputted score or other assessment that represents a relative likelihood that the requested return is abusive or fraudulent. The assessment may be integrated into a return authorization process to provide an authorization determination to a clerk processing the return transaction at the point of return 125.

As depicted in FIG. 5, data collected during a requested return transaction 510 (e.g., the type of merchandise being returned, the merchandise condition, the time of the return request, the location of the return request, the clerk processing the return, etc), together with existing stored data 520, which may comprise information about the customer, the clerk, the store, and/or other stored data, are processed to create variables 530 that are indicators of fraud. As described herein, a receipt identifier 505 can be used to identify data associated with the original purchase of the merchandise being returned from the sales data 525, and one or more customer identifiers can be extracted from the original purchase data. The customer identifiers can be used to retrieve stored data 520 associated with the customer who purchased the merchandise (who is presumably also the same customer requesting the return).

Examples of the types of stored data 520 that may be used may include, but are not limited to: current and past return-related transaction data from this customer 110 at this and other branches of the merchant's establishment 120 (or from additional other merchants), other transaction data collected from point-of-sale systems operated by the merchant 120, employee records, information regarding the merchandise whose return is being requested, transaction data collected at points of return 125 from other customers thought to be related to this customer 110 by home address, family name, or other connecting data, information about the store where the return is taking place, information about the merchant, and/or information associated with seasonal considerations associated with return transaction activity. Other types of data that may be used include, but are not limited to, merchandise SKU codes or other identifiers, data from other merchants, criminal records, address history records, credit data, data about identification theft, address information, and the like.

The variables 530 may be simple variables, based directly on data inputted at one or more POR devices 126, such a number of items being returned, and/or may be more complex variables that the system calculates based on two or more pieces of stored or inputted data, such as a percent, average, median, maximum, minimum, or sum of other data item subsets, values relating to a person's pattern of travel, measure of consumer profitability, sales and return seasonality, and any other value which can be derived from the stored and/or inputted data. The variables, 530 may be used to update the repository of stored data 520 and are used to create or supply input data to a fraud detection model 540. Several variables which can be considered by the fraud detection model 540 are discussed in connection with FIG. 6. It will be understood that other determinations can be made in addition to, or instead of, the detection of fraud or abuse. For example, in some embodiments, the collected data 510 and/or the stored data 520 can be used to decide whether to present a coupon or other offer to a consumer requesting the merchandise return, and what the appropriate coupon or offer is.

As will be familiar to one of skill in the art, a wide variety of methods, including ruled-based, statistical, and other methods, are available for use, alone or in combination, to construct a model for use with a decision-making system. For example, the fraud detection model 540 may be created using one or more statistical methodologies, including, for example, logistic regression, linear regression, discriminant analysis, or some other modeling technique such as fuzzy logic systems, feed-forward neural networks, Bayesian or other probabilistic system. The fraud detection model 540 uses the variables 530 to determine a fraud score 550 that indicates the determined likelihood that fraud is occurring on the return transaction or that the customer 110 is abusing the merchant's return policy.

For example, the following pseudocode describes one embodiment of a fraud score 550 calculation using the variables 530:

SCORE=−11.6828285287;

SCORE=SCORE+A*B*−0.2903944075;

SCORE=SCORE+C*0.4347462065;

SCORE=SCORE+A*1.0274579996;

SCORE=SCORE+D*E*0.0224254388;

SCORE=SCORE+D*E²*−0.0000414985;

SCORE=SCORE+F*0.4890091670;

SCORE=SCORE+G*−0.4883078393;

SCORE=SCORE+H*1.1295824050;

SCORE=SCORE+I*0.1874589093;

SCORE=SCORE+J*3.4938824622;

where the variables, based on a given customer's previous transactions with one or more of the merchant's branches, have the following meanings, and where for variables marked with a ˜symbol, transactions occurring within fifteen minutes of one another count as a single transaction:

A=Number of return transactions in any 365 day period which had the same amount;

B=˜Number of non-receipted return transactions in the past thirty days;

C=˜Number of receipted return transactions in the past thirty days;

D=Average amount over all return transactions is less than $25 (0=true, 1=false);

E=Percentage of returns without a receipt;

F=Average amount of all return transactions;

G=Percentage of returns that result in a net positive payment to the merchant;

H=˜Number of stores visited in the past thirty days where a return was made;

I=˜Number of return transactions in the past 365 days;

J=Average number of stores visited in the twenty-four hours before all transactions.

In some embodiments, in order to generate a score in the range from 1-1000, the following conversion may be applied to the value for SCORE:

SCORE=round(1000/(1+exp(−SCORE))).

Many variations are possible. In some embodiments, only a subset of the variables A-J is applied to the fraud score calculation. For example, in a system in which no returns are allowed without a receipt or in which returns made with no receipt are not tracked and associated with a customer, the use of the variable E (Percentage of returns without a receipt) can be omitted.

This set of sample calculations generates a score in which a higher score indicates a higher level of risk associated with accepting the merchandise return. For example, in some embodiments, a score generated using such a set of calculations may be approved if the score is less than eight hundred, denied if the score is greater than nine hundred, and approved with a warning about the acceptance of future merchandise returns if the score is between eight hundred and nine hundred. In other embodiments using the above-described scoring example, a customer whose merchandise return request receives a score above nine hundred on a first occasion may be approved with a warning, while the same customer may be denied on a second occasion that a merchandise return receives a score over nine hundred.

As will be familiar to one of skill in the art, a wide variety of methods for calculating and using scores may be used in conjunction and as a part of the systems and methods described herein. For example, in some embodiments, two or more scores may be generated for a requested merchandise return, and an assessment may consider some or all of the scores in making an authorization determination. As will be further familiar to one of skill in the art, systems and methods that employ other ways of assessing risk and/or otherwise deciding whether to authorize a merchandise return, such as rule-based systems, may be used in place of or in addition to calculating one or more scores 550.

To continue with the example of FIG. 5, the score 550 is then used by a return decision process to activate business rules 560 specified by the merchant 120. For example, one or more business rules 560 may establish that customers 110 whose requested return transaction is assigned a score 550 that is above a pre-determined threshold value may have their return accepted, customers 110 whose requested return transaction is assigned a score 550 that is below the pre-determined threshold value may have their return denied. In some embodiments, one or more business rules 560 may specify that acceptance or denial of a requested return transaction may be based on more than just the calculated score 550, and may, for example, take into consideration specific factors relevant to the merchant's return policy 150.

In some embodiments, one or more business rules 560 may pertain to the issuance of return-related warnings to the customer 110 and may specify conditions under which a warning is issued to a customer 110. For example, in one score-based embodiment where a lower score indicates a higher degree of risk, if a score 550 for a requested return transaction is above the pre-determined threshold by only a small margin that falls within a predetermined range, a warning may be printed on a transaction receipt 330 presented to the customer 110 together with the return approval. As another example, in embodiments where frequency of returns causes the calculated score 550 to drop, and if another return by the customer 110 within a short period of time would likely receive a score 550 that falls below the threshold, a warning may be printed on the transaction receipt 330, notifying the customer 110 of this situation, and, in some embodiments, providing an indication to the customer 110 of the length of time during which merchandise returns are not likely to be accepted.

As described above, a variety of factors may influence a determination of whether a requested return is to be accepted or denied. When acceptance of a requested return is authorized, a further determination may be made as to whether to issue a warning to the customer 110 about possible future limitations on the customer's ability to make future merchandise returns. In some embodiments, the warning determination is implemented as a separate determination that is initiated once a requested return transaction is accepted. In other embodiments, the warning determination is implemented in conjunction with the authorization determination. For example, in one score-based system embodiment, scores that fall within one or more pre-determined ranges may cause a return to be authorized without inclusion of a warning to the customer, while scores that fall within one or more other pre-determined ranges may generate an authorization that includes a warning about possible limitations on future returns.

Once the return authorization service 100 has determined that issuance of a warning is warranted, the warning may be presented to the customer 110 in a variety of forms. In some preferred embodiments, the warning is printed or otherwise visually displayed on the receipt 330 that is provided to the customer 110 by the clerk at the point of return 125. In some embodiments, the clerk is not visually or otherwise directly notified of the inclusion of the warning. Instead, the POR device 126 may be configured to receive an indication of the warning determination from the return authorization service 100 and to automatically print the warning on the receipt 330. Additionally or alternatively, the warning may be displayed on an electronic display for viewing by the customer, may be provided via email or other electronic transmission, verbally by the clerk, hand-written at the point of return, in other printed form, such as a postcard or other mailed notification, aurally, or by another communication method.

When the warning is printed on the receipt 330, the warning may, in some embodiments, appear as a text message on the receipt. For example, a message on the receipt may state, “Dear Customer, Your current return is approved, but you will now be unable to return additional merchandise for sixty days.” Thus, the warning may include information about a period of time during which merchandise return from the customer may not be accepted. In other embodiments, a printed warning may include an explanation that, in accordance with one or more of the merchant's return guidelines, the customer may have exceeded or is likely to exceed a threshold score on an upcoming return. Alternatively, or additionally, text printed on the receipt 330 may include a listing of the customer's recent return and/or purchase transactions.

A color code, such as a red/yellow/green color code, may be employed, in other embodiments, to indicate to the customer 110 the severity of the warning. The color code may be implemented by actually using colored ink or other colored indicator on the receipt, such as color of the receipt paper itself. Alternatively, the color code may be a code name that is presented to the customer using text. For example, a customer's return transaction receipt may have printed on it: “Dear Valued Customer, Your return code color is Green. Accordingly, you currently have normal return privileges,” or “Dear Valued Customer, Your return code color is red. Accordingly, you may not make another return for sixty days.” In such systems, “warnings” serve the function of reporting a customer's current return authorization status and may be provided to customers whose return requests have been approved, regardless of score or other assessment.

As an alternative to or in addition to the above, the return authorization service 100 may, in some embodiments, calculate a numerical score that indicates the strength of the warning and transmit that score to the POR device 126 for display to the customer 110. The score may be a score that was used by the return authorizations service 100 to determine whether to authorize the return. Alternately, the score may be based on another scoring system, such as a simplified or specialized scoring system that is selected for communicating a warning to the customer 110.

In yet another embodiment, the warning may be presented pictorially, using, for example, a bar graph, pie chart, or other graphical indicator of the customer's status with respect to the return threshold level. For example, a “thermometer” chart may characterize excessive or otherwise suspicious return behavior as getting “hot” as it approaches the threshold.

As will be understood by a practitioner of skill in the art, combinations of one or more of the foregoing warning systems, as well other similar systems may be used to provide return-related warnings for the customer requesting to make a return.

FIG. 6 depicts a set of factors that influence one embodiment of a process for making a determination 600 in connection with a requested merchandise return (e.g., whether to authorize the request, whether to issue a warning, what warning to issue, whether to issue a coupon, and what coupon to issue). In other embodiments, a different set of factors, including some, all, or none of the factors depicted in FIG. 6, may influence a determination 600 of whether to authorize the requested return. Furthermore, as described herein, some or all of the factors may influence a determination 600 as to whether to issue a warning or a coupon to the customer requesting that a merchandise return transaction be accepted.

Broadly speaking, the factors may include information about the current return, information about the customer's identification, information about the customer's past purchase and/or return history, as well as general information about the store and other related data.

For example, as depicted in FIG. 6, factors associated with the current return transaction may include information about an identifier 601 for the clerk handling the return, and in some embodiments an identifier for the clerk(s) who handled the associated purchase transaction, a dollar amount associated with the requested return 602, the items in the current return 603, a receipt for the items being returned 604, the age of the receipt 605, the type of return 606 requested by the customer, and the type of merchandise being returned relative to the merchant type 607. Other factors associated with the current return transaction may include, but not be limited to, a location and/or identifier for the merchant, the day, date and/or time of the requested return 619, an amount of time lapsed since purchase of the items being returned, and information about other customers in the merchant location 120 during the time of the requested return transaction. Another factor that may be considered in making the determination 600 is the department or category of the item being returned. For example, in a department store, returns from a clothing department may be handled differently than returns from a sporting goods department. In some cases, products can be separated into categories (e.g., using SKU code categories) which can influence the determination 600. Thus, products in a single department or in a store that does not include separate departments (e.g., a specialty store) can be separated into distinct categories. As one possible example, in a sporting goods store or department, the return of skis or a snowboard may lead to an automatic warning to the customer that no returns of skis or snowboards may be made for a predetermined time (e.g., 6 weeks). Another factor which can influence the determination 600 is the location in the store where the return is being made. For example, a particular register within a merchant's store may be favored by abusers (e.g., a register near an exit, or a register in a department with little activity or far from a manager's office), and returns made at the fact that a customer selects this register for a return can influence the determination 600.

The dollar amount associated with the return 602 may include a net return dollar amount, for example, the dollar amount of the requested return without tax, or the net amount of the return with any discounts taken into consideration. The dollar amount 602 may additionally or alternatively include a net transaction amount that takes into consideration the amount of the return amount and the amount of any purchases and/or exchanges being made by the customer at the same time.

Information about items presented for return 603 may include information about one or more item identifiers (bar code, Stock Keeping Unit code (SKU), Universal Product Code (UPC), Radio Frequency Identifier (RFID), and the like), information about individual item prices and merchandise types, as well as a total number of items being returned.

Information about one or more purchase receipts 604 for the items being presented for return 604 may include, for example, date of the receipt, one or more data items that serve to identify the receipt, and whether a receipt is presented by the customer for each returned item. As described herein, the receipt can be used to locate the sales data associated with the purchases of the merchandise being returned, and one or more customer identifiers can be extracted from the located sales data. The customer identifiers can be used to identify or generate other variables used in making the determination 600. In some embodiments, the determination 600 may consider data associated with one or more additional customer identifiers 621, which were not extracted from the sales data for the particular receipt associated with the present return, but which were previously identified as belonging to the same consumer as a customer identifier that was extracted from the sales data for the present return.

Factors associated with the customer's identification may include a matching of the identification and/or biometric information 616 offered by the customer at the point of return 125 with stored identification and/or biometric information about the customer 110. For example, information about fingerprint, retina, voice and/or facial or other metrics may be used. Additionally, information about the customer's current and, possibly, past home addresses 620 may serve as a factor in the determination 600 that may be used to calculate the geographical distance 615 from the customer's home to the store. The customer's home address may also be compared to stored information about the clerk's home address in order to rule out a possibly fraudulent and usually forbidden processing of the return transaction by clerk who shares a home address with the customer 110. The customer's address can also be compared against a “negative list” of addresses known to be associated with fraudulent returns. In some embodiments, previous purchase data and/or previous returns data associated with other customers that share the same address as the customer 110 who is requesting the current merchandise return 622 can also influence the determination 600.

Additional information about the customer, such as, for example, birth date, state of residence, state of identification card, identification number, loyalty card number, gift card number, checking account number, coupon number, merchandise credit slop number, phone number(s), credit card number, check number, debit card number, receipt authorization code, license expiration date, and any information available may also be used as factors. In some embodiments, identification of the customer allows for determining whether the customer is included on a “positive list” of customers whose returns may be automatically accepted or authorized more easily, or a “negative list” of customers whose returns may be automatically rejected or scrutinized more carefully, or another subset of customers whose merchandise returns may be processed in a special manner. Furthermore, other available types of information about the customer, such as credit information, check information address history, and possible shoplifting record or other criminal record information may also be useful as a factor.

In some embodiments information about the customer may be obtained from an ID provided by the customer (e.g., a driver's license). In some embodiments, the system may prompt the clerk to ask a customer who requests a merchandise return for proof of ID if no ID is yet on file for the customer identifier(s) extracted from the sales data associated with the provided receipt. For subsequent returns in which those customer identifier(s) are extracted, no proof of ID would be needed, and the customer information could be accessed by the association previously made to the customer identifier(s). In some embodiments, the return authorization system can make the determination 600 without any proof of ID ever being obtained from the customer. Customer information may be obtained from external sources. For example, if a customer number is a credit card number used to make the merchandise purpose, customer information may be obtained from the credit card company. Also, a clerk may input customer information.

A wide variety of factors regarding the customer's history of purchase and/or return transactions may influence the determination 600. For example, two factors are the number of returns 613 and the dollar amount of the returns 612, as well as the dollar amounts and identifiers of the individual merchandise items, that the customer has requested within one or more recent periods of interest, including, in some embodiments, the occurrence of any denied return transactions. Dates, times, and locations of previous requested returns may be a factor, as well as previous return authorization scores or other assessments determined for the customer and past returns for the same items as the current return. Another factor is the number of unreceipted returns 611 that the customer has requested within one or more recent periods of interest. The identifiers for the clerks handling previous returns 610 and the geographic distances from the locations of other recent returns 614, the number of different locations of recent returns 623, as well as the number of returns within a pre-determined geographic area, may be used as factors in the determination 600. In addition, in some embodiments, information about the customer's purchase history 609 with the merchant, including, for example, dollar amounts, numbers of items, price and identifiers of individual items, and number of recent purchases, payment types and payment history, previous warnings received, previous authorization scores, may influence the determination 600. Additional factors of interest associated with the customer's past transactions may include information about discounts and/or credit associated with previous purchases and/or overrides associated with past returns, as well as past payment information.

In addition to the above-described factors, other factors may influence an authorization determination 600, as suits the preferences of the merchant 120. As one example, the merchant 120 may desire to have seasonal considerations 608 influence the authorization determination 600, for example, rejecting fewer returns during the holiday shopping season, or alternatively, allowing more returns while issuing more warnings. Seasonal considerations 608 may also affect subsequent determinations 600, such as in embodiments in which returns made during a holiday period are “weighed” less heavily against the customer than returns made at other times of the year. Current and/or past address data associated with employees may also be a factor, as well as override information associated with the employees.

Other types of information available from external sources 618, either publicly available free information and/or purchased information may serve as factors. For example, sales tax information, postal box information, census data, householding data, identification theft data, Department of Commerce data, credit data, bank data, check data, crime data, loan delinquency data, and the like may be received from sources external to the return authorization service 100 and used to make a determination 600. Some or all such data 618 may be stored for later use and/or may be accessed from one or more external sources on an as-needed basis.

Furthermore, data that has been collected by other merchants 617, including data collected in association with purchase and/or return transactions and authorizations, may be shared with the merchant 120 and used as factors in the determination 600.

With respect to the process for determining when to authorize a return and the process for determining whether to issue a warning or a coupon, any one of the factors described herein with reference to FIG. 6 or in any other portion of this disclosure may be used by the decision engine 135 as a single or separate factor, or may be used in combination with any subset of the factors 601-623 to make a determination 600. For example, in some embodiments, customer identification information 616 may be used in conjunction with any one or more of the following types of information to make a determination: original receipt date, dollar amount of the return without tax, net return transaction amount, number of items being returned, SKU identifier(s) for returned item(s), RFID identifier(s) for returned item(s), and receipt identifier or combination of uniquely identifying data items for the receipt. In other embodiments, other single factors or combinations of factors may be used to make the determination 600.

Thus, the process for determining when to authorize a return, the process for determining whether to issue a warning (and what warning to issue), and the process for determining whether to offer a coupon (and what coupon to offer) may be highly customized to the business preferences of the merchant 120, if desired, and may be tailored to include factors deemed relevant and practical for the merchant's business.

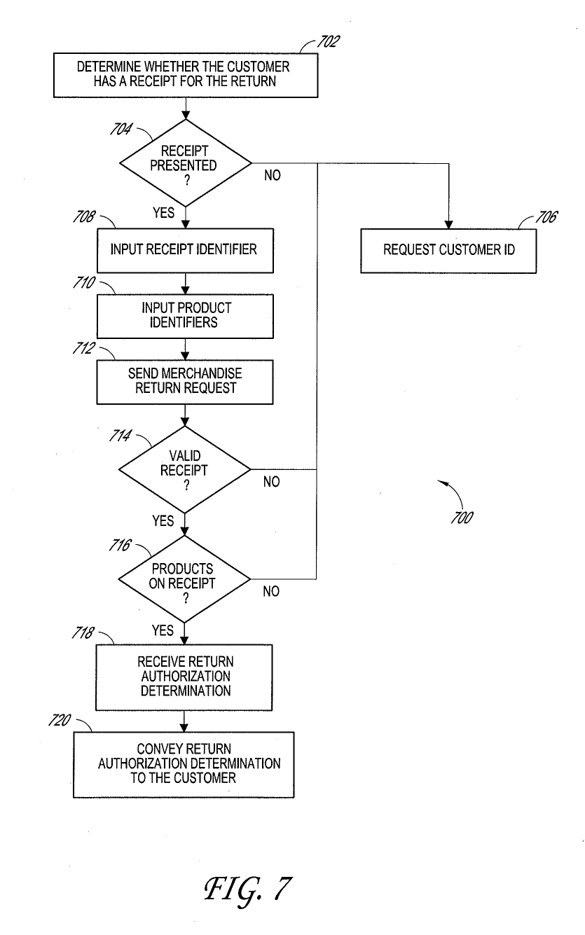

FIG. 7 is a flowchart that illustrates one embodiment of a process 700 for processing a requested merchandise return. The process 700 begins at block 702, wherein a clerk at the point of return 125 determines whether the customer requesting the merchandise return has a receipt for the return. If, in block 704, the customer does not have a receipt for the return, the process 700 can proceed to block 706 where the clerk requests a proof of ID (e.g., a driver's license) from the customer. If the customer provides a proof of ID, provided ID can be used to identify the customer and prior return and purchase data associated with the customer, for example, as described in U.S. Pat. No. 7,455,226, the entirety of which is hereby incorporated by reference.

If, at block 704, the customer does present a receipt for the requested return, the process 700 can proceed to block 708 in which the clerk inputs the receipt identifier (e.g., using a bar code scanner, or by inputting the number manually using a keypad). At block 710, The clerk can input product identifiers for the products being returned. The clerk can, for example, scan bar codes on the products using a bar code scanner or input a SKU number or a UPC number or other identifier using a keypad.

At block 712, a merchandise return request can be sent, for example, to a return authorization service 100 for evaluation. If at block 714, it is determined that the receipt is not valid, the process 706 can proceed to block 706 where the clerk asks the customer for proof of ID. Many variations are possible. For example, if no sales data for the receipt identifier is found, the return could be automatically rejected, automatically accepted, or may be limited to a return for store credit. In some cases, no sales data is found for a receipt identifier because the sales data has not yet been transferred to the return authorization service 100 (e.g., if a customer returns an item on the same day it was purchased and before a daily scheduled batch sales data transfer). In some cases, no sales data is found because the receipt itself is fraudulent. Also, there may be instances in which sales data is not properly collected or transferred to the return authorization service 100 thereby creating voids in the sales data.

If at block 716, if the products being returned are not located on the receipt (e.g., the product aren't represented in the sales data associated with the receipt identifier), the return may be treated as a return with no receipt and the process 700 can proceed to Block 706.

If, at block 714, the receipt is valid and, at block 716, merchandise being returned is on the receipt, the process 700 can proceed to block 718, where an authorization determination is received from the return authorization service 100. The determination received can include a determination of whether to accept or deny the return request, whether to issue a warning (and what warning to issue), and/or whether to offer a coupon (and what coupon to offer). At block 720, the determination is conveyed to the customer via the clerk, a POR device, a printed coupon, or other suitable manner. Thus, in some embodiments, the return request can be processed without asking the customer to provide a confirmation of ID, which can lead to increasing the merchant's good will, identifying more abusers, and deterring fraudulent returns, as discussed above.

As will be familiar to one of skill in the art, other embodiments of the process 700 described in FIG. 7 may be carried out by executing the functions described in FIG. 7 in a different order, by dividing the functions in another manner, and/or by including some or all of the functions described above in conjunction with other associated functions. For example, the determination of whether the receipt is valid (at block 714) may be performed immediately after the receipt identifier is inputted (at block 708) and before the product identifiers are inputted (at block 710). Other variations are possible. For example, in the process 700 (or other processes disclosed herein) certain steps may be omitted. For example, the decision block 716 can be omitted, such that no determination as to whether the products are on the receipt is made.

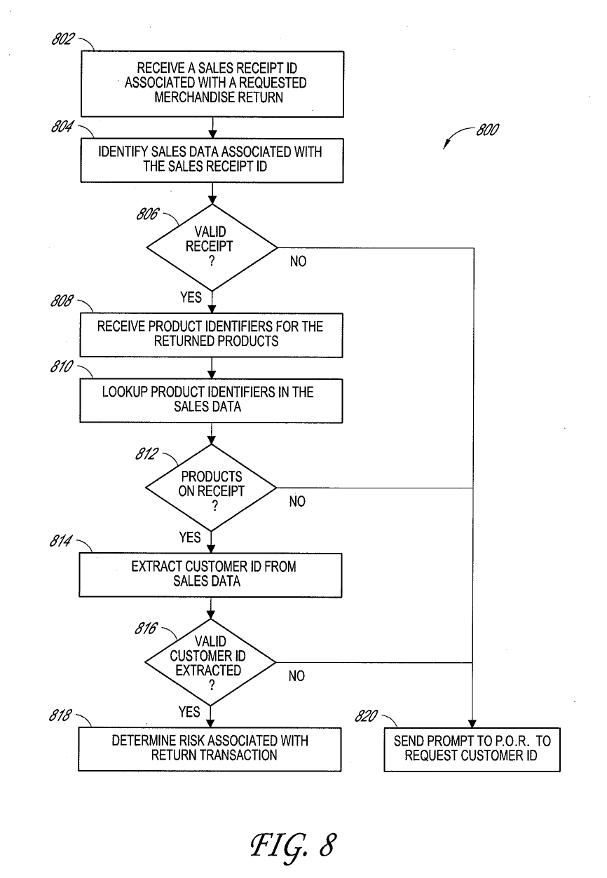

FIG. 8 is a flowchart that illustrates one embodiments of a process 800 for processing a merchandise return request. The process 800 can be performed, for example, by the return authorization service 100. The process 800 starts at block 802, in which the return authorization service 100 receives a sales receipt identifier that is associated with the requested merchandise return. At block 804, sales data associated with the receipt identifier is identified from within a repository of sales data. If no sales data is located, at block 806 the receipt is determined to be invalid. The process can then proceed to block 820, in which the return authorization service 100 sends a prompt to the clerk (e.g., via the POR device) to request for proof of ID from the customer. Alternatively, the clerk may be sent a prompt to ask the customer if a different receipt applies to the return.

If sales data is located for the receipt identifier, the process proceeds to block 808 in which product identifiers for the products being returned are received. At block 810, the product identifiers are looked up in the located sales data. If the products identifiers are not present in the located sales data (block 812), indicating that the products are not listed on the receipt (e.g., the customer has presented an incorrect or fraudulent receipt), the process 800 can proceed to block 820 where system sends a prompt to the clerk to ask for customer ID. Alternatively block 820 can instruct the clerk to have the customer double check the receipt. If the products are listed on the receipt, then from block 812, the process 800 can proceed to block 814, in which one or more customer identifiers are extracted from the located sales data that relates to the original purchase of the merchandise being returned. The extracted customer number(s) can be, for example, customer loyalty number, merchant-specific customer ID numbers, hashed credit card, debit card, or checking account number, etc.

If, at block 816, no valid customer identifier was extracted, the process 800 can proceed to block 820, where the system can send a prompt to the clerk to ask the customer for proof of ID. Alternatively, at block 820, the system can simply determine to accept or to deny the requested return, or to determine a risk associated with the return transaction based on the history of the receipt (e.g., were the items on the receipt already returned previously). In some cases the sales data associated with a receipt does not contain any information that can be used as a customer identifier, for example if a customer made the purchase using cash and did not provide an ID or loyalty card for the transaction. In some cases a customer identifier can be extracted from the located sales data, but the system can treat the customer identifier as being invalid if the customer identifier has insufficient historical data to be used in assessing the risk for the requested return (e.g., if a purchase was made with a new credit card with no previous purchases or returns).

If, at block 816, at least one valid customer identifier was extracted, the process proceeds to block 818, where the system determines the risk associated with the requested return transaction. The determination of block 818 can be based at least in part on stored customer data associated with the extracted customer identifier(s), as described herein.

As will be familiar to one of skill in the art, other embodiments of the process 800 described in FIG. 8 may be carried out by executing the functions described in FIG. 8 in a different order, by dividing the functions in another manner, and/or by including some or all of the functions described above in conjunction with other associated functions. In some embodiments, certain steps can be omitted. For example, in some cases, blocks 810 and/or 812 can be omitted.

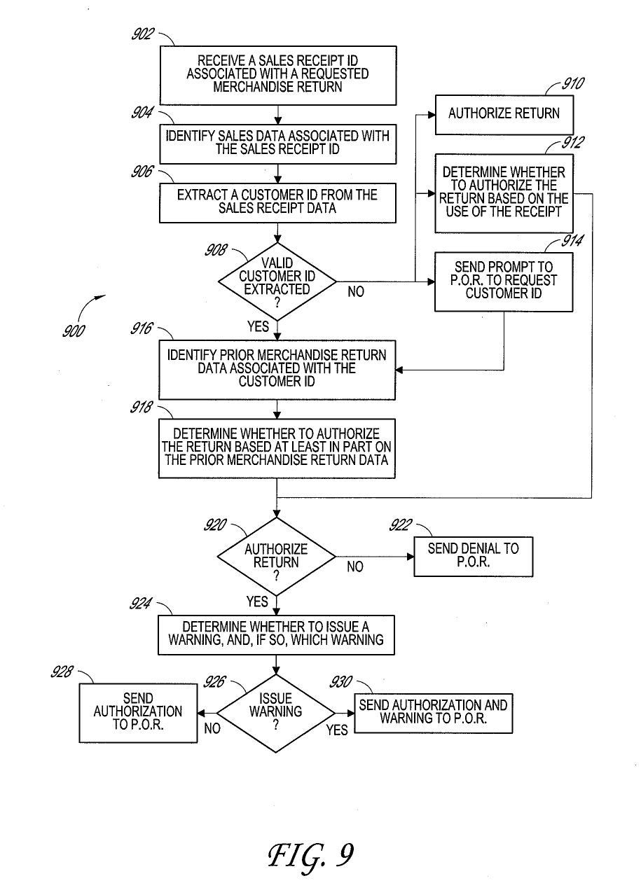

FIG. 9 is a flowchart that illustrates an example embodiment of a process 900 for making determinations for a requested merchandise return. The process 900 can be performed, for example, by a return authorization service 100. The process 900 starts at block 902, where a sales receipt identifier for the requested return is received. At block 904, the system locates sales data associated with the receipt identifier. At block 906, the system extracts one or more customer identifiers from the sales receipt data.

If one or more valid customer numbers were extracted, then, at block 908, the process 900 proceeds to block 916, in which the system identifies prior merchandise return data associated with the extracted customer identifier(s). Additional or alternative customer data relating the customer identifier(s) can be identified, such as prior merchandise purchase data, customer address, etc. At block 918, the system can determine whether to authorize the return based at least in part on the prior merchandise return data and/or other data identified at block 916. If, at block 920, the return is to denied, the system can send a denial to the POR device at block 922, or otherwise communicate the denial to the clerk and/or to the customer. In some cases, a restriction can be placed on future returns associated with the customer in addition to the denial of the currently requested return. The restriction may be communicated to the clerk and/or to the customer (e.g., using a POR device). The restriction may vary depending on a score calculated for the requested return or the particular circumstances of the return or other factors discussed herein. For example, if a requested return is denied, the customer can be informed that no returns will be permitted for 30 days.

If, at block 920, the return is to be authorized, the system can proceed to block 924, in which the system determines whether to issue a warning, and if so which warning to issue. If it is determined that no warning is to be issued (at block 926), the process 900 can proceed to block 928, in which the authorization of the requested return can be sent to the POR device, or otherwise communicated to the customer and/or the clerk. If a warning is to be issued, the process may proceed to block 930, in which both the authorization and the warning are sent to the POR, or are otherwise communicated to the clerk and the customer.

Returning now to block 908, if no valid customer identifier was extracted, the process 900 can proceed to one of blocks 910, 912, or 914. In some cases the sales data associated with a receipt does not contain any information that can be used as a customer identifier, for example if a customer made the purchase using cash and did not provide an ID or loyalty card for the transaction. In some cases a customer identifier can be extracted from the located sales data, but the system can treat the customer identifier as being invalid if the customer identifier has insufficient historical data to be used in assessing the risk for the requested return (e.g., if a purchase was made with a new credit card with no previous purchases or returns).

At block 910, the system simply authorizes the return. For example, an authorization determination can be sent to the POR device or otherwise be communicated to the clerk and/or customer. At block 912, the system determines whether to authorize the requested return based on the receipt and sales data. For example, if the receipt associated with the present return request had been used previously to return the merchandise that is the subject of the present return request, the system can make a determination to reject the return request even without accessing any customer data. After block 912, the process can proceed to block 920. At block 914, a prompt can be sent to the POR instructing the clerk to request proof of ID from the customer. Once the customer's ID has been received, the process can proceed to block 916 and continue substantially as previously described. Although not shown in FIG. 9, another alternative is that the system may automatically deny the return request if no valid customer number was extracted.

As will be familiar to one of skill in the art, other embodiments of the process 900 described in FIG. 9 may be carried out by executing the functions described in FIG. 9 in a different order, by dividing the functions in another manner, and/or by including some or all of the functions described above in conjunction with other associated functions. For example, in some embodiments, no warning determination is made, and blocks 924, 926, and 930 can be omitted. Also, in some embodiments, the method 900 can also determine whether to offer a coupon to the customer as part of the return request authorization. In some embodiments, the determination of whether to authorize the requested return at block 918 can be based, at least in part, on the receipt (e.g., if the receipt has been previously used to return the merchandise for which the current return request is made) as described in connection with block 912 even when a valid customer identifier is extracted.

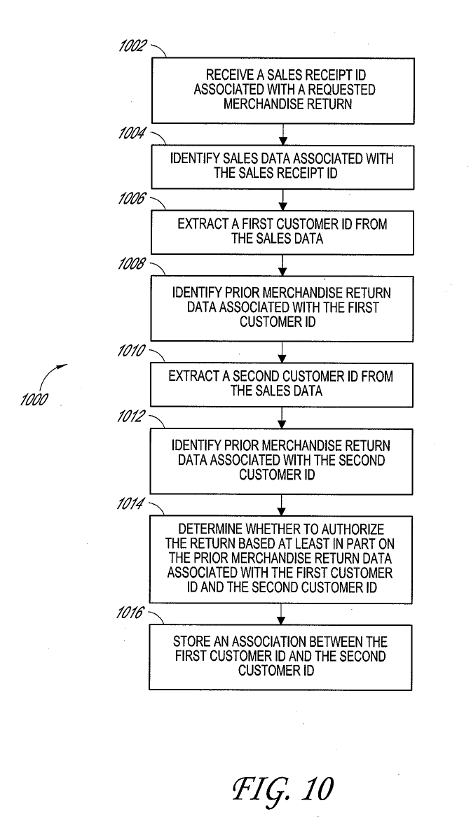

FIG. 10 is a flowchart that illustrates an example embodiment of a process 1000 for linking customer identifiers together. The process 1000 can be performed, for example, by a return authorization service 100. At block 1002, the system receives a sales receipt identifier associated with the requested merchandise return. At block 1004, the system locates sales data associated with the receipt identifier. At block 1006, a first customer identifier is extracted from the located sales data. At 1008, the system identifies prior merchandise return data associated with the first customer identifier, and/or other customer data. At block 1010, a second customer identifier is extracted from the located sales data. At block 1012, the system identifies prior merchandise return data associated with the second customer identifier, and/or other customer data.

At block 1014, the system determines whether to authorize the requested return based at least in part on the prior merchandise return data, or other customer data, associated with the first customer identifier and the prior merchandise return data, or other customer data, associated with the second customer identifier. At block 101, the system can store an association between the first customer number and the second customer number. Thus, for future return requests, if one of the two customer identifier is extracted, the customer data for both customer numbers can be considered.

As will be familiar to one of skill in the art, other embodiments of the process 1000 described in FIG. 10 may be carried out by executing the functions described in FIG. 10 in a different order, by dividing the functions in another manner, and/or by including some or all of the functions described above in conjunction with other associated functions. For example, in some embodiments the determination made in block 1014 can be whether to restrict the customer's future returns, whether to issue a warning to the customer, and/or whether to issue a coupon to the customer. Also, in some embodiments, blocks 1002 and 1004 can be omitted, and the sales data can be received in response to a purchase made by the customer. Thus, by searching through purchase sales data a greater number of links between customer identifiers can be identified, as compared to only finding links when a return transaction occurs.

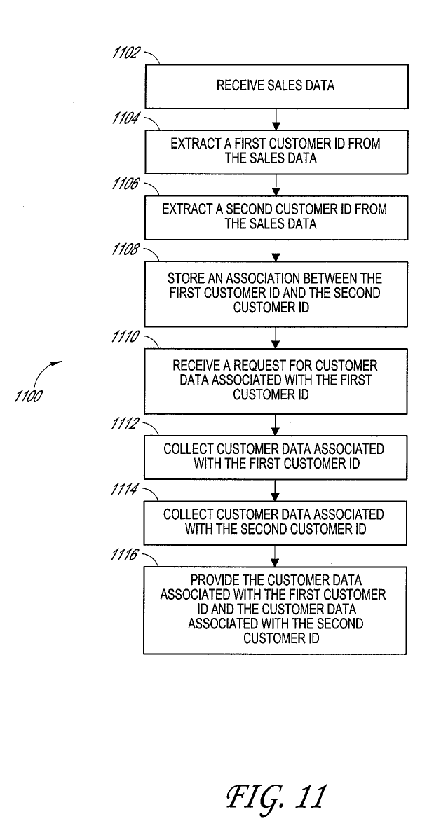

FIG. 11 is a flowchart that illustrates an example embodiment of a process 1100 for tracking consumers. At block 1102, sales data is received. Sales data can be received as part of a batch of purchase sales data, as data received for an individual transaction, or as data located as being related to a requested merchandise return. At block 1104, a first customer identifier is extracted from the sales data. At 1106, a second customer identifier is extracted from the sales data. At block 1108 an association is stored between the first customer identifier and the second customer identifier. At block 1110, a request is received for customer data associated with the first customer identified, and at block 1112 customer data associated with first customer identifier is collected. At block 1114, customer data associated with the second customer identifier is collected, because the system recognized the previously stored association between the first and second customer identifiers. At block 1116, the system can provide the customer data associated with the first customer identifier and also the customer data associated with the second customer identifier in response to the request received at block 1110.

As will be familiar to one of skill in the art, other embodiments of the process 1100 described in FIG. 11 may be carried out by executing the functions described in FIG. 11 in a different order, by dividing the functions in another manner, and/or by including some or all of the functions described above in conjunction with other associated functions.

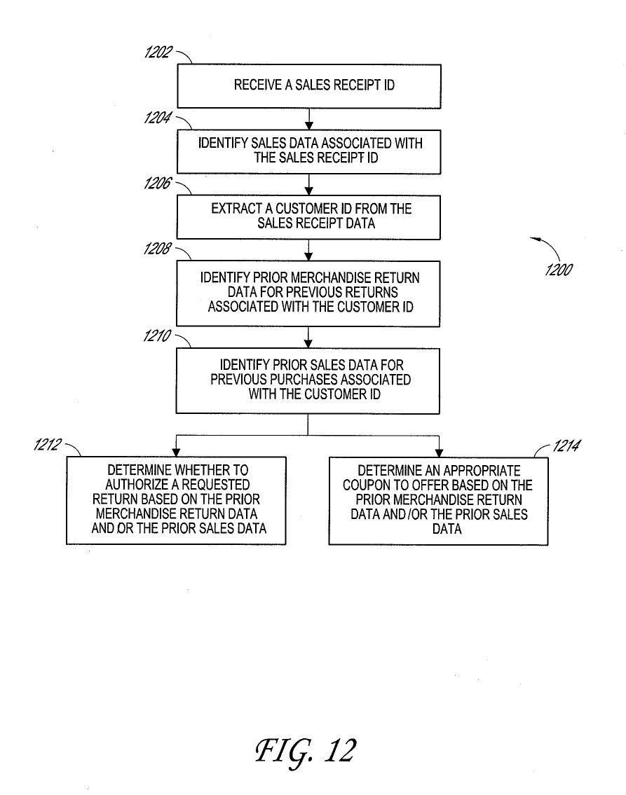

FIG. 12 is a flowchart that illustrates an embodiment of a process 1200 for making determinations based upon prior merchandise return data and prior sales data for a customer. In block 1202, the system receives a sales receipt identifier. At block 1204, the system locates sales data associated with the receipt identifier. At block 1206, a customer identifier is extracted from the located sales data. At 1208, the system identifies prior merchandise return data associated with the customer identifier. At block 1210, the system identifies prior purchases data associated with the customer identifier. At block 1212, the system can determine whether to authorize a requested merchandise return based at least in part on the prior merchandise return data and/or the sales data for prior purchases. In some embodiments, block 1214 can be performed in addition to, or instead of block 1212. In block 1214, the system can determine, based at least in part on the prior merchandise return data and/or the sales data for prior purchases, whether to provide a coupon to the customer, and what coupon should be offered. In some embodiments, the coupon offer may be specially tailored to the customer. For example if a customer's prior purchases data indicates that the customer frequently purchases a product of a particular type, the coupon may be for a product of that type or of a related type. For example, if a customer frequently purchases baseball equipment at the merchant, the coupon may be for a discount on other sporting equipment.

As will be familiar to one of skill in the art, other embodiments of the process 1200 described in FIG. 12 may be carried out by executing the functions described in FIG. 12 in a different order, by dividing the functions in another manner, and/or by including some or all of the functions described above in conjunction with other associated functions. For example, in some embodiments, block 1208 or block 1210 can be omitted. For example, a coupon determination may be based on prior purchases data, but not prior returns data.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the disclosure. Accordingly the scope of the invention is determined by the claims recited below, not by the specific examples presented above.

What is claimed is:

1. A method for determining whether to authorize a requested merchandise return, the method comprising:
receiving sales data associated with merchandise purchases made by one or more consumers;
receiving merchandise return data associated with merchandise returns made by the one or more consumers;
storing the sales data and the merchandise return data in one or more databases stored in a computer readable medium;
receiving a sales receipt identifier for a sales receipt associated with a requested merchandise return made by a consumer;
accessing the one or more databases to identify the sales data associated with the sales receipt identifier for the requested merchandise return;
extracting a customer identifier from the sales data for the requested merchandise return;
identifying prior merchandise return data associated with the same customer identifier obtained from the sales data; and
automatically determining, using a return authorization system that includes one or more computer processors in communication with the computer readable medium, whether to authorize or deny the requested merchandise return based at least in part on the prior merchandise return data.

2. The method of claim 1, further comprising receiving requested merchandise return data for the requested merchandise return, wherein the determination of whether to authorize or deny the requested merchandise return is based at least in part on the requested merchandise return data.

3. The method of claim 1, further comprising accessing sales data associated with prior purchases associated with the customer identifier, and wherein the determination of the level of risk associated with the requested merchandise return is based at least in part on the sales data associated with the prior purchases.

4. The method of claim 1, further comprising notifying the consumer of whether the requested merchandise return is authorized or denied.

5. The method of claim 1, further comprising determining, using the return authorization system, whether to restrict future merchandise returns made by the consumer.

6. The method of claim 1, further comprising extracting a second customer identifier from the sales data for the requested merchandise return.

7. The method of claim 6, further comprising identifying prior merchandise return data associated with the second customer identifier for the requested merchandise return, wherein the determination of whether to authorize or deny the requested merchandise return is based at least in part on prior merchandise return data associated with the second customer identifier.

8. The method of claim 6, further comprising storing in the one or more databases an association between the merchandise return data associated with the initial customer identifier and the merchandise return data associated with the second customer identifier.

9. The method of claim 1, further comprising identifying one or more additional customer identifiers that are associated with the extracted customer identifier, wherein the determination of whether to authorize or deny the requested merchandise return is based at least in part on prior merchandise return data associated with the one or more additional customer identifiers.

10. A system for determining whether to authorize a requested merchandise return, the system comprising:
one or more databases stored in a computer readable medium comprising sales data associated with merchandise purchases made by one or more consumers, and merchandise return data associated with merchandise returns made by the one or more consumers;
a customer identifier extraction system configured to:
receive a sales receipt identifier for a sales receipt associated with a requested merchandise return made by a consumer;
access the one or more databases to identify the sales data associated with the sales receipt identifier for the requested merchandise return; and
extract a customer identifier from the sales data for the requested merchandise return; and
a return authorization system configured to:
access the one or more databases to identify prior merchandise return data associated with the same customer identifier extracted from the sales data; and
determine whether to authorize or deny the requested merchandise return based at least on the prior merchandise return data.

11. The system of claim 10, wherein the return authorization system is configured to:
receive requested merchandise return data for the requested merchandise return; and
determine whether to authorize or deny the requested merchandise return based at least in part on the requested merchandise return data.

12. The system of claim 10, wherein the customer identifier extraction system is configured to extract a second customer identifier from the sales data for the requested merchandise return.

13. The system of claim 12, wherein the return authorization system is configured to:
identify prior merchandise return data associated with the second customer identifier extracted from the sales data; and
determine whether to authorize or deny the requested merchandise return based at least in part on the prior merchandise return data associated with the second customer identifier.

14. The system of claim 12, wherein the customer identifier extraction system is configured to store in the one or more databases an association between the merchandise return data for the initial customer identifier and the merchandise return data for the second customer identifier.

15. The system of claim 14, wherein the customer identifier extraction system is configured to search the one or more databases to identify one or more additional customer identifiers that are associated with the extracted customer identifier, and wherein the authorization system is configured to determine whether to authorize or deny the requested merchandise return based at least in part on prior merchandise return data associated with the one or more additional customer identifiers.

16. A method for determining the level of risk associated with a requested merchandise return, the method comprising:
receiving a sales receipt identifier for a sales receipt associated with a requested merchandise return made by a consumer;
accessing one or more databases stored in a computer readable medium to identify sales data associated with the sales receipt identifier for the requested merchandise return;
extracting a customer identifier from the sales data associated with the sales receipt identifier;
accessing the one or more databases to identify customer data associated with the customer identifier obtained from the sales data; and
automatically determining, using a return authorization system that includes one or more computer processors in communication with the computer readable medium, the level of risk associated with the requested merchandise return based at least in part on the customer data associated with the customer identifier obtained from the sales data.

17. The method of claim 16, further comprising automatically determining, using the return authorization system, whether to authorize or deny the requested merchandise return based at least in part on the level of risk associated with the requested merchandise return.

18. The method of claim 16, further comprising automatically determining, using the return authorization system, to restrict future returns made by the consumer based at least in part on the level of risk associated with the requested merchandise return.

19. The method of claim 18, further comprising preparing a warning relating to the restricted future returns to be presented the consumer.

20. The method of claim 16, wherein the customer data comprises prior merchandise return data associated with the customer identifier, and wherein the determination of the level of risk associated with the requested merchandise return is based at least in part on the prior merchandise return data.

21. The method of claim 16, wherein the customer data comprises sales data associated with prior purchases associated with the customer identifier, and wherein the determination of the level of risk associated with the requested merchandise return is based at least in part on the sales data associated with the prior purchases.

22. The method of claim 1, wherein the customer identifier comprises a customer loyalty number, a hashed credit card number, a hashed debit card number, a hashed checking account number, a credit card number, a debit card number, a check account number, or a merchant-specific customer ID number.

23. The method of claim 16, wherein the customer data comprises the consumer's address.

24. The method of claim 23, further comprising accessing the one or more databases to identify merchandise return data associated with one or more additional consumers that have the same address as the consumer associated with the customer identifier, and wherein the determination of the level of risk is determined at least in part by the merchandise return data associated with the one or more additional consumers.

25. The method of claim 16, further comprising extracting a second customer identifier from the sales data associated with the sales receipt identifier.

26. The method of claim 25, further comprising identifying customer data associated with the second customer identifier, wherein the determination of whether to authorize or deny the requested merchandise return is based at least in part on customer data associated with the second customer identifier.

27. The method of claim 25, further comprising storing in the one or more databases an association between the initial customer identifier and the second customer identifier.

28. The method of claim 16, further comprising identifying one or more additional customer identifiers that are associated with the initial customer identifier, wherein the determination of whether to authorize or deny the requested merchandise return is based at least in part on customer data associated with the one or more additional customer identifiers.

29. A system for identifying previous purchases made by a consumer, the system comprising:
one or more databases stored in a computer readable medium comprising sales data associated with merchandise purchases made by one or more consumers; and
a customer identifier extraction system configured to:
receive a sales receipt identifier for a sales receipt associated with one of the merchandise purchases previously made by a consumers;
access the one or more databases to identify the sales data associated with the sales receipt identifier for the purchase previously made; and
extract a customer identifier from the sales data associated with the sales receipt identifier; and
a data collection system configured to access the one or more databases to identify customer data associated with the customer identifier extracted from the sales data associated with the receipt identifier.

30. The system of claim 29, wherein the receipt is associated with a requested merchandise return made by the consumer, and wherein the system further comprises a return authorization system configured to determine the level of risk associated with the requested merchandise return based at least in part on the customer data associated with the customer identifier obtained from the sales data associated with the receipt identifier.

31. The system of claim 30, wherein the return authorization system is configured to determine whether to authorize or deny the requested merchandise return based at least in part on the level of risk associated with the requested merchandise return.

32. The system of claim 30, wherein the return authorization system is configured to determine whether to restrict future returns made by the consumer based at least in part on the level of risk associated with the requested merchandise return.

33. The system of claim 29, further comprising a coupon generation system configured to determine an appropriate coupon to offer the customer based at least in part on the customer data associated with the customer identifier obtained from the sales data associated with the receipt identifier.

34. The system of claim 33, wherein the customer data comprises prior sales data, wherein the data collection system is configured to access the one or more databases to identify the prior sales data for one or more additional prior purchases associated with the same customer identifier extracted from the sales data associated with the receipt identifier, and wherein the coupon generation system is configured to determine the appropriate coupon to offer the customer based at least in part on the prior sales data.

35. The system of claim 33, wherein the customer data comprises prior merchandise return data, wherein the data collection system is configured to access the one or more databases to identify the prior merchandise return data associated with merchandise returns previously performed by the customer, and wherein the coupon generation system is configured to determine the appropriate coupon to offer the customer based at least in part on the prior merchandise return data.

36. The system of claim 33, wherein the coupon generation system is configured to determine whether to offer the customer a coupon based at least in part on the customer data associated with the customer identifier.

37. The system of claim 33, wherein the receipt is associated with a requested merchandise return made by the consumer.

38. A method for tracking merchandise purchases of consumers, the method comprising:
receiving sales data associated with merchandise purchases made by one or more consumers;
storing the sales data in one or more databases stored in a computer readable medium;
obtaining sales data associated with a particular purchase made by a consumer;
extracting, using a customer identifier extraction system, a first customer identifier from the sales data associated with a particular purchase made by a consumer;
extracting, using the customer identifier extraction system, a second customer identifier from the sales data associated with a particular purchase made by a consumer; and
storing, in the one or more databases, an association between the first customer identifier and the second customer identifier.

39. The method of claim 38, further comprising:
receiving a request for customer data associated with the first customer identifier;
accessing the one or more databases, using a data collection system, in response to the request and identifying customer data associated with the first customer identifier;
identifying the association between the first customer identifier and the second customer identifier;
accessing the one or more databases, using a data collection system, in response to the request and identifying customer data associated with the second customer identifier; and
providing a response to the request, the response comprising the customer data associated with the first customer identifier and the customer data associated with the second customer identifier.

40. The method of claim 38, wherein obtaining the sales data associated with the particular purchase comprises:
receiving a receipt identifier associated with the receipt associated with the requested merchandise return made by the consumer; and
accessing the one or more databases to identify the sales data for the particular purchase relating to the requested return.

41. The method of claim 38, wherein obtaining the sales data associated with the particular purchase comprises receiving the sales data associated with the particular purchase in response to the customer making the particular purchase.
